(19) United States
(12) Patent Application Publication
(10) Pub. No.: US 2024/0332752 A1
(43) Pub. Date: Oct. 3, 2024

(54) TABLESS BATTERY

(71) Applicant: Murata Manufacturing Co., Ltd., Nagaokakyo-shi (JP)

(72) Inventors: Akira SHINKAWA, Nagaokakyo-shi (JP); Akira OTANI, Nagaokakyo-shi (JP); Masashi TAKAHASHI, Nagaokakyo-shi (JP); Yasuaki HARA, Nagaokakyo-shi (JP)

(21) Appl. No.: 18/620,698

(22) Filed: Mar. 28, 2024

Related U.S. Application Data
(60) Provisional application No. 63/456,103, filed on Mar. 31, 2023.

(51) Int. Cl. H01M 50/538; H01M 10/04; H01M 50/107; H01M 50/474; H01M 50/533

(52) U.S. Cl. CPC H01M 50/538; H01M 10/0431; H01M 50/107; H01M 50/474; H01M 50/533

(57) ABSTRACT

An electrode wound body includes positive and negative electrodes, and a separator between the positive electrode and the negative electrode. The positive electrode includes a positive foil extension extending from a positive electrode foil. The negative electrode includes a negative foil extension extending from a negative electrode foil. The positive electrode, the negative electrode, and the separator are wound to define a spiral including a through hole with a central axis extending through the through hole. The positive foil extension and the negative foil extension extend from opposite ends of the electrode wound body. Portions of the positive foil extension include bends that bend towards the central axis so that the portions of the positive foil extension overlap to define a first surface. Portions of the negative foil extension include bends that bend towards the central axis so that the portions of the negative foil extension overlap to define a second surface.

### CROSS REFERENCE TO RELATED APPLICATIONS

This application claims the benefit of U.S. Patent Application No. 63/456,103 filed on Mar. 31, 2023. The entire contents of this application are hereby incorporated by reference.

### BACKGROUND OF THE INVENTION

### 1. Field of the Invention

The present invention relates to batteries. More specifically, the present invention relates to tabless rechargeable batteries.

### 2. Description of the Related Art

Lithium-ion batteries have been developed for applications that require high power, such as electric tools and automobiles. Methods to achieve high power include a method of high-rate discharge of the flow of a relatively large current from a battery. The high-rate discharge has a problem with the internal resistance of the battery because of the flow of the large current.

Conventional battery technology, for example, has a problem in that, because welding points are denser toward the center to collect current from the whole wound foil ends, simply folding and overlapping the foil produces a region with less overlap of the foils on the center side of the electrode assembly, which is perforated at the time of welding. Another problem is that a sufficient space is required in the central portion of the electrode assembly when welding the can bottom in the assembly process, and when the foil is folded from the outer periphery toward the central portion, the central space formed at the time of the winding is blocked, thereby failing to achieve the assembly.

### SUMMARY OF THE INVENTION

To overcome the problems described above, example embodiments of the present invention provide batteries that include bends in the positive and negative electrode foils, that provide a high-rate discharge, and that can be reliably welded.

According to an example embodiment of the present invention, an electrode wound body includes a positive electrode, a negative electrode, a separator between the positive electrode and the negative electrode. The positive electrode includes a positive electrode foil, a positive electrode active material on a portion of the positive electrode foil, and a positive foil extension extending from the positive electrode foil. The positive electrode active material is not on the positive foil extension. The negative electrode includes a negative electrode foil, a negative electrode active material on a portion of the negative electrode foil, and a negative foil extension extending from the negative electrode foil. The negative electrode active material is not on the negative foil extension. The positive electrode, the negative electrode, and the separator are wound to define a spiral including a through hole with a central axis extending through the through hole. The positive foil extension extends from a first end of the electrode wound body. The negative foil extension extends from a second end of the electrode wound body opposite to the first end. Portions of the positive foil extension include first bends that bend towards the central axis so that the portions of the positive foil extension overlap to define a first surface. The positive foil extension includes a first groove in the first surface. Portions of the negative foil extension include second bends that bend towards the central axis so that the portions of the negative foil extension overlap to define a second surface. The negative foil extension includes a second groove in the second surface.

A bottom surface of the first groove can be curved, and a bottom surface of the second groove can be curved. A first curvature of the first groove can be less than a second curvature of the second groove.

The second groove can be deeper than the first groove. Each of the first and the second grooves can have a rectangular cross section. Portions of the separator can include third bends. Portions of the positive electrode active material can include fourth bends, and portions of the negative electrode active material can include fifth bends. A portion of the positive electrode foil and/or a portion of the negative electrode foil can be folded over an innermost portion of the separator closest to the through hole.

Some portions of the positive foil extension can include multiple first bends, some portions of the negative foil extension can include multiple second bends, and a number of the multiple first bends of the positive foil extension can be greater than a number of the multiple second bends of the negative foil extension. First bending shapes of the first bends of the positive foil extension can be asymmetric with respect to the central axis, and second bending shapes of the second bends of the negative foil extension can be asymmetric with respect to the central axis. The electrode wound body can further include a cavity between radially adjacent first bends of the positive foil extension or between radially adjacent second bends of the negative foil extension.

The first surface can be substantially smooth with a glossy appearance, and the second surface can be substantially smooth with a glossy appearance.

A first distance between radially adjacent portions of the positive foil extension can decrease as a second distance to the negative electrode active material increases, and a third distance between radially adjacent portions of the negative foil extension can decrease as a fourth distance from the positive electrode active material increases.

A first distance between radially adjacent portions of the positive foil extension can decrease as a second distance to the through hole decreases, and a third distance between radially adjacent portions of the negative foil extension can decrease as a fourth distance to the through hole decreases.

A fitting degree of radially adjacent portions of the positive foil extension can increase as a first distance to the through hole decreases, and a fitting degree of radially adjacent portions of the negative foil extension can increase as a second distance to the through hole decreases.

According to an example embodiment of the present invention, a battery includes an exterior can and an electrode wound body of one of the various other example embodiments of the present invention in the exterior can.

The battery can further include a positive electrode current-collecting plate joined to the first surface and including a first flat fan-shaped portion and a first rectangular band-shaped portion and can include a negative electrode current-collecting plate joined to the second surface and including a second flat fan-shaped portion and a second rectangular band-shaped portion.

After the positive electrode current-collecting plate and the negative electrode current-collecting plate are joined to the first and second surfaces, respectively, the first groove may not retain a cross-sectional shape, and the second groove can retain a cross-sectional shape.

The first fan-shaped portion of the positive electrode current-collecting plate can include a first curved portion and two first straight-line portions with two first lines of the two first straight-line portions being co-linear, and the second fan-shaped portion of the negative electrode current-collecting plate can include a second curved portion and two second straight-line portions with two second lines of the two second straight-line portions being co-linear.

The first flat fan-shaped portion and the first rectangular band-shaped portion of the positive electrode current-collecting plate can be connected at two first curved corners, and the second flat fan-shaped portion and the rectangular band-shaped portion of the negative electrode current-collecting plate can be connected at two second curved corners.

The battery can further include a positive insulator that is joined to the positive electrode current-collecting plate and that includes a larger hole that is aligned with the through hole and that includes smaller holes arranged around the larger hole and can further include a negative insulator that is joined to the negative electrode current-collecting plate and that includes a hole that is aligned with the through hole.

According to an example embodiment of the present invention, an electrode wound body includes a positive electrode, a negative electrode, a separator between the positive electrode and the negative electrode. The positive electrode includes a positive electrode foil, a positive electrode active material on a portion of the positive electrode foil, and a positive foil extension extending from the positive electrode foil. The positive electrode active material is not on the positive foil extension. The negative electrode includes a negative electrode foil, a negative electrode active material on a portion of the negative electrode foil, and a negative foil extension extending from the negative electrode foil. The negative electrode active material is not on the negative foil extension. The positive electrode, the negative electrode, and the separator are wound to define a spiral including a through hole with a central axis extending through the through hole. The positive foil extension extends from a first end of the electrode wound body. The negative foil extension extends from a second end of the electrode wound body opposite to the first end. Portions of the positive foil extension include first bends that bend towards the central axis so that the portions of the positive foil extension overlap to define a first surface. First bending shapes of the first bends of the positive foil extension can be asymmetric with respect to the central axis. Portions of the negative foil extension include second bends that bend towards the central axis so that the portions of the negative foil extension overlap to define a second surface. Second bending shapes of the second bends of the negative foil extension can be asymmetric with respect to the central axis.

Some portions of the positive foil extension can include multiple first bends, some portions of the negative foil extension can include multiple second bends, and a number of the multiple first bends of the positive foil extension can be greater than a number of the multiple second bends of the negative foil extension. Portions of the separator can include third bends. Portions of the positive electrode active material can include fourth bends, and portions of the negative electrode active material can include fifth bends. A portion of the positive electrode foil and/or a portion of the negative electrode foil can be folded over an innermost portion of the separator closest to the through hole.

The positive foil extension includes a first groove in the first surface, and the negative foil extension includes a second groove in the second surface. A bottom surface of the first groove can be curved, and a bottom surface of the second groove can be curved. A first curvature of the first groove can be less than a second curvature of the second groove. The second groove can be deeper than the first groove. Each of the first and the second grooves can have a rectangular cross section.

The electrode wound body can further include a cavity between radially adjacent first bends of the positive foil extension or between radially adjacent second bends of the negative foil extension.

The first surface can be substantially smooth with a glossy appearance, and the second surface can be substantially smooth with a glossy appearance.

A first distance between radially adjacent portions of the positive foil extension can decrease as a second distance to the negative electrode active material increases, and a third distance between radially adjacent portions of the negative foil extension can decrease as a fourth distance from the positive electrode active material increases.

A first distance between radially adjacent portions of the positive foil extension can decrease as a second distance to the through hole decreases, and a third distance between radially adjacent portions of the negative foil extension can decrease as a fourth distance to the through hole decreases.

A fitting degree of radially adjacent portions of the positive foil extension can increase as a first distance to the through hole decreases, and a fitting degree of radially adjacent portions of the negative foil extension can increase as a second distance to the through hole decreases.

According to an example embodiment of the present invention, a battery includes an exterior can and an electrode wound body of one of the various other example embodiments of the present invention in the exterior can.

The battery can further include a positive electrode current-collecting plate joined to the first surface and including a first flat fan-shaped portion and a first rectangular band-shaped portion and can include a negative electrode current-collecting plate joined to the second surface and including a second flat fan-shaped portion and a second rectangular band-shaped portion.

After the positive electrode current-collecting plate and the negative electrode current-collecting plate are joined to the first and second surfaces, respectively, the first groove may not retain a cross-sectional shape, and the second groove can retain a cross-sectional shape.

The first fan-shaped portion of the positive electrode current-collecting plate can include a first curved portion and two first straight-line portions with two first lines of the two first straight-line portions being co-linear, and the second fan-shaped portion of the negative electrode current-collecting plate can include a second curved portion and two second straight-line portions with two second lines of the two second straight-line portions being co-linear.

The first flat fan-shaped portion and the first rectangular band-shaped portion of the positive electrode current-collecting plate can be connected at two first curved corners, and the second flat fan-shaped portion and the rectangular band-shaped portion of the negative electrode current-collecting plate can be connected at two second curved corners.

The battery can further include a positive insulator that is joined to the positive electrode current-collecting plate and that includes a larger hole that is aligned with the through hole and that includes smaller holes arranged around the larger hole and can further include a negative insulator that is joined to the negative electrode current-collecting plate and that includes a hole that is aligned with the through hole.

The above and other features, elements, characteristics, steps, and advantages of the present invention will become more apparent from the following detailed description of example embodiments of the present invention with reference to the attached drawings.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is schematic view of a sectional view of a battery.

FIG. 2 is a schematic diagram illustrating an example of a relationship among a positive electrode, a negative electrode, and a separator in an electrode wound body.

FIG. 3A is a plan schematic view of a positive electrode current-collecting plate.

FIG. 3B is a plan schematic view of a negative electrode current-collecting plate.

FIGS. 4A-4F are schematic diagrams illustrating a process of assembling a battery.

FIG. 5A is schematic drawing of the negative side of a battery showing lines of the various cross-sections shown in FIGS. 6A-9D.

FIG. 5B is a photograph corresponding to FIG. 5A of the negative side of a battery showing lines of the various cross-sections shown in FIGS. 6A-9D.

FIG. 6A is a schematic drawing of a cross-section of the positive side of a battery along grooves in the positive foil extension.

FIG. 6B is a schematic drawing of a cross-section of the negative side of a battery along grooves in the negative foil extension.

FIG. 6C is a photograph corresponding to FIG. 6A of a cross-section of the positive side of a battery along grooves in the positive foil extension.

FIG. 6D is a photograph corresponding to FIG. 6B of a cross-section of the negative side of a battery along grooves in the negative foil extension.

FIG. 7A is closeup schematic drawing of FIG. 6A.

FIGS. 7B-7D are closeup trace drawings of a photograph of portions of FIG. 7A.

FIG. 7E is closeup schematic drawing of FIG. 6B.

FIGS. 7F-7H are closeup trace drawings of a photograph of portions of FIG. 7E.

FIG. 71 is a photograph corresponding to FIG. 7A.

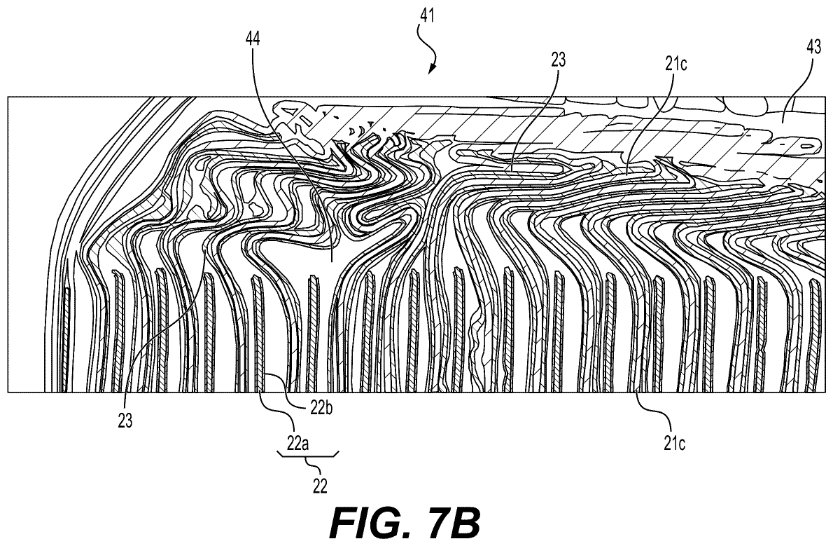

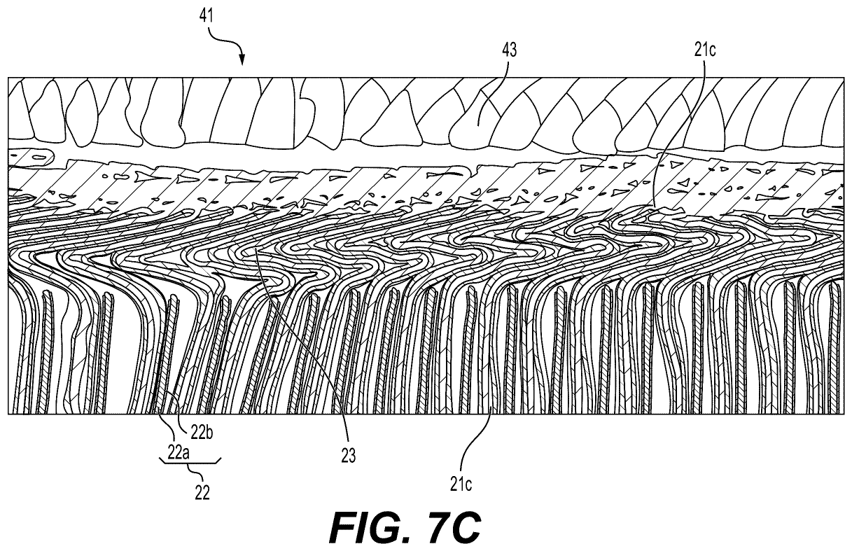

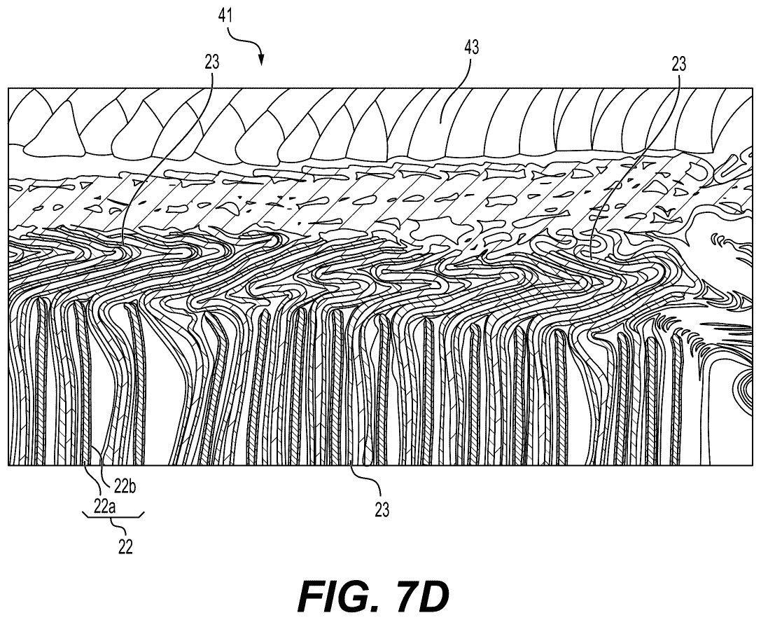

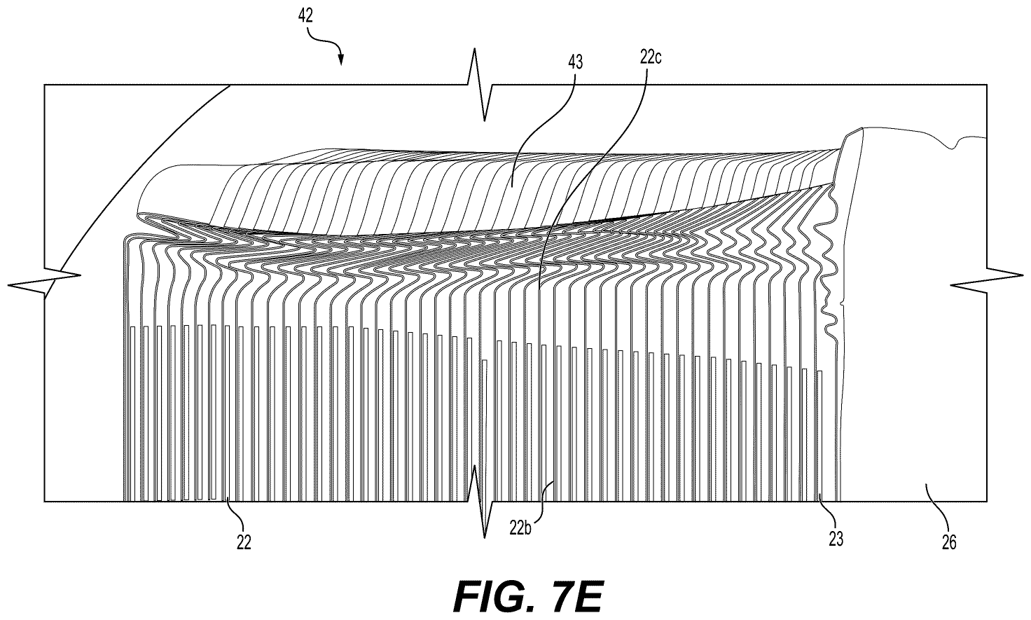

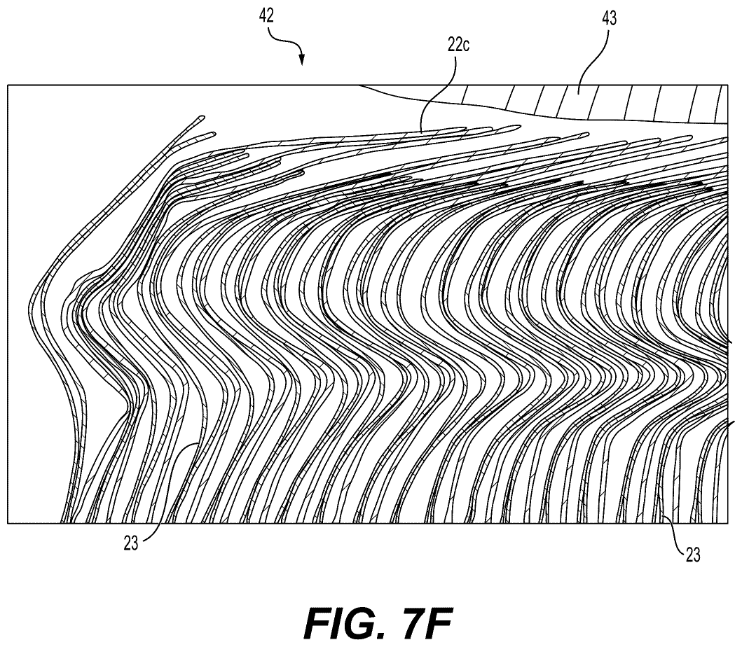

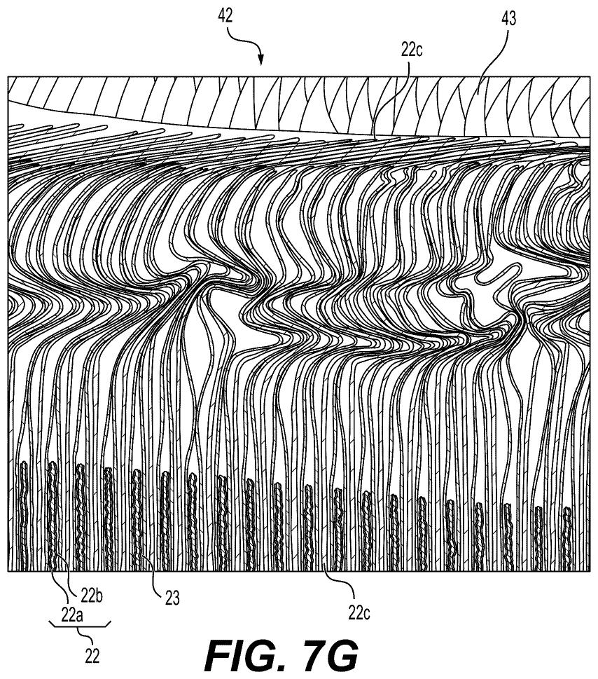

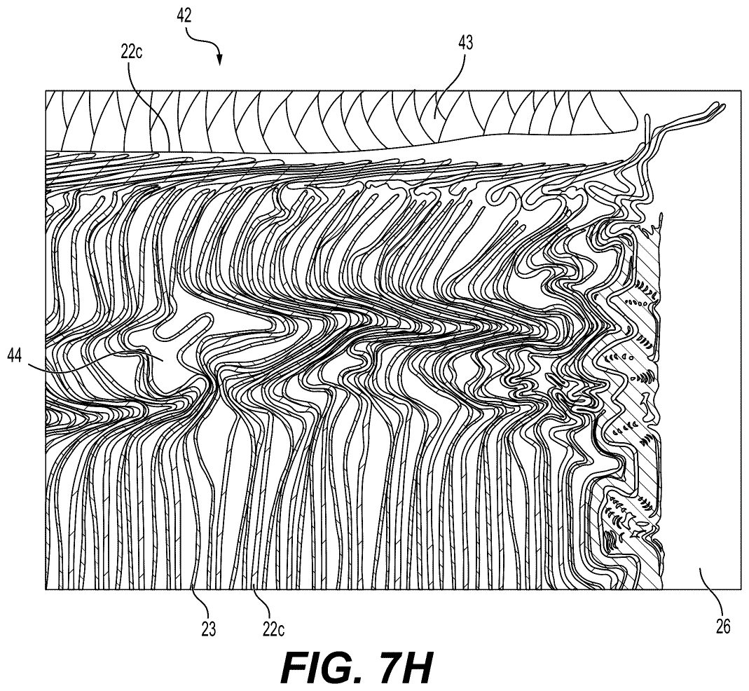

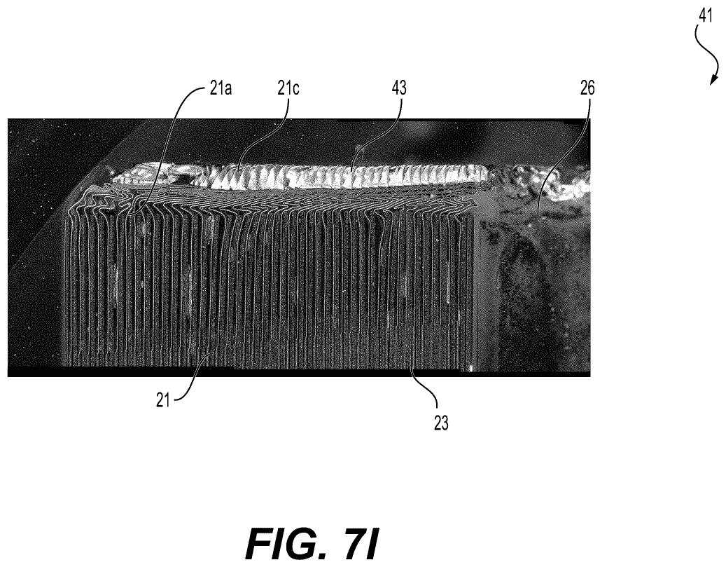

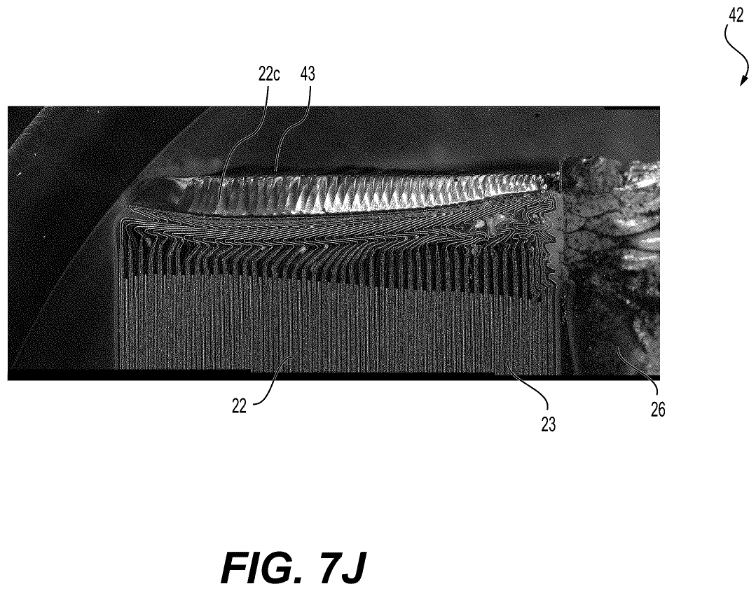

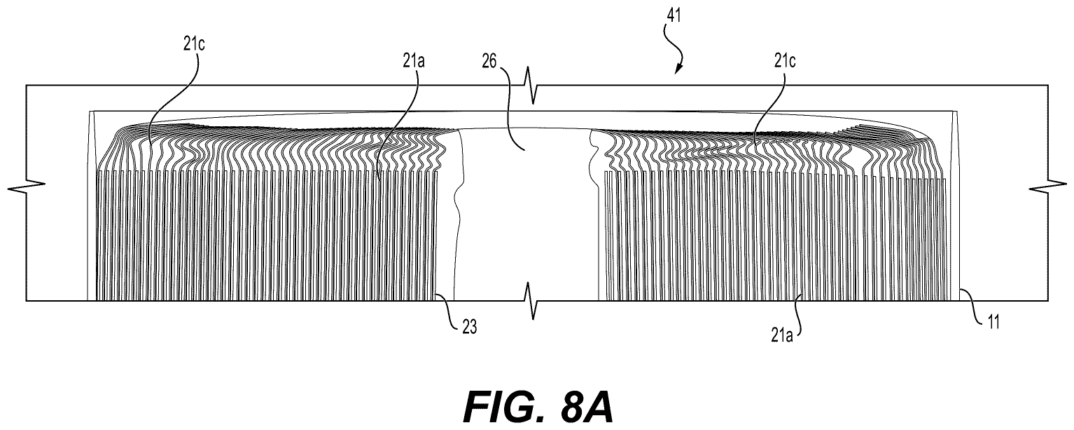

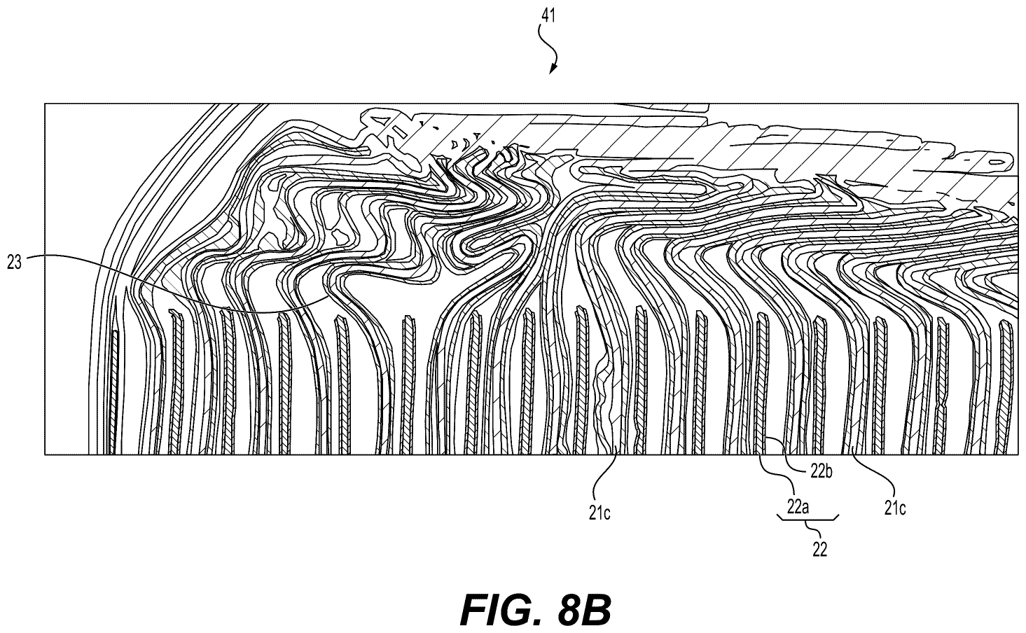

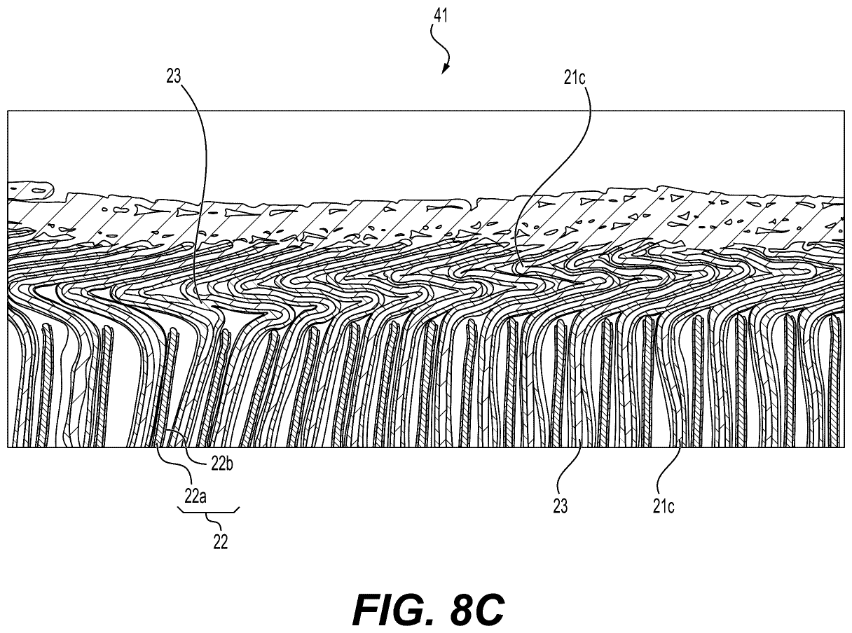

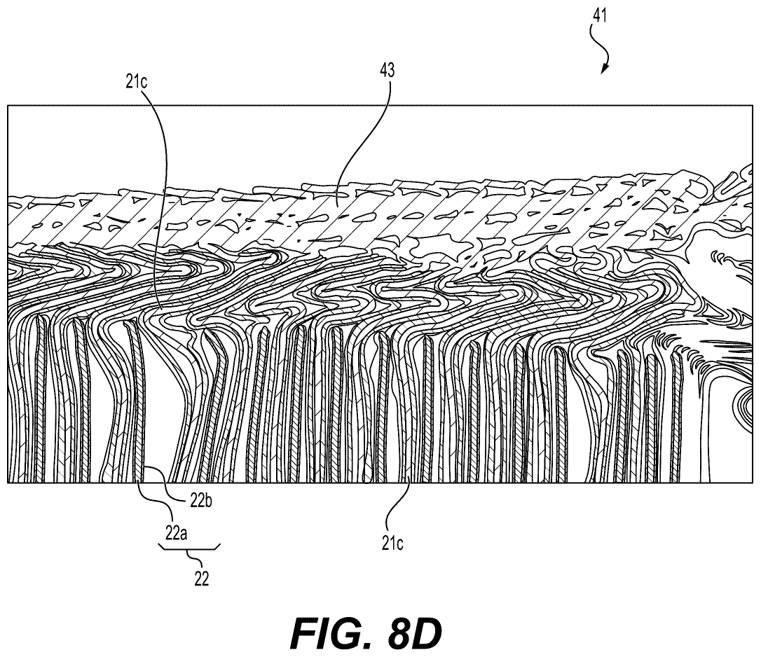

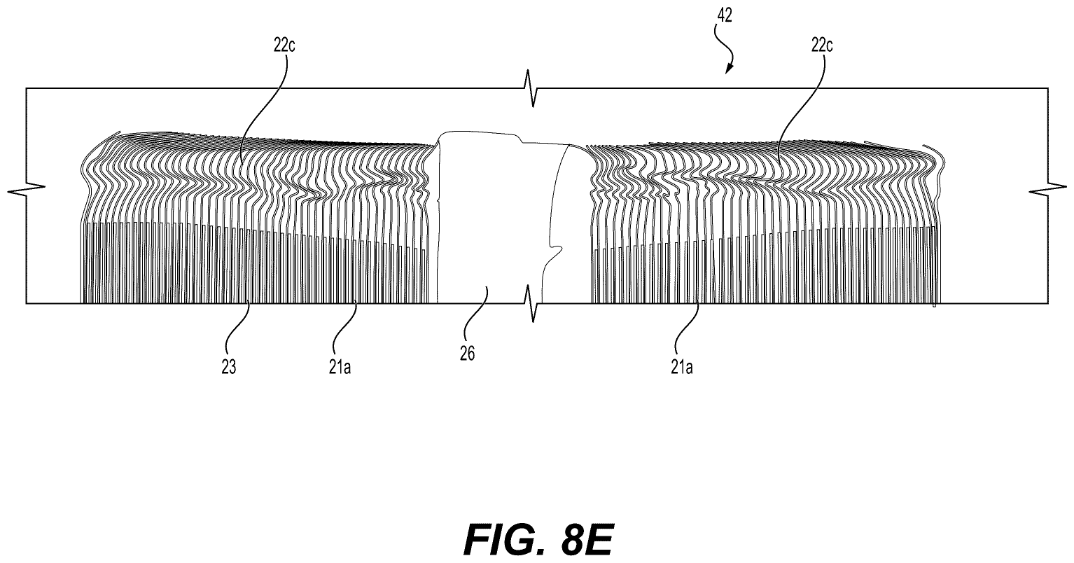

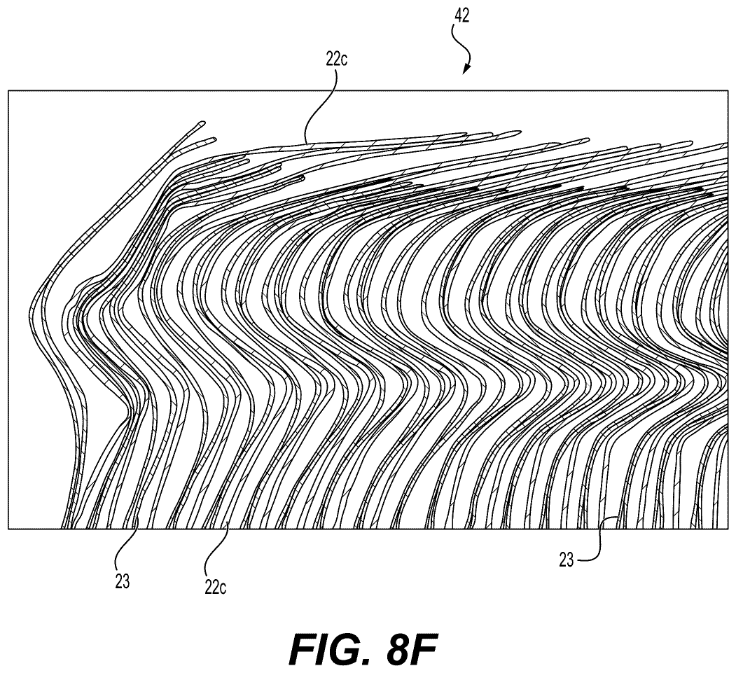

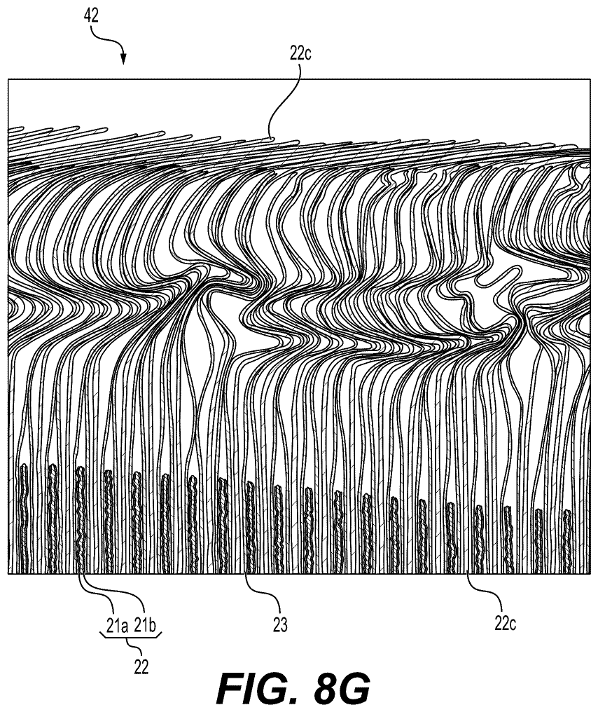

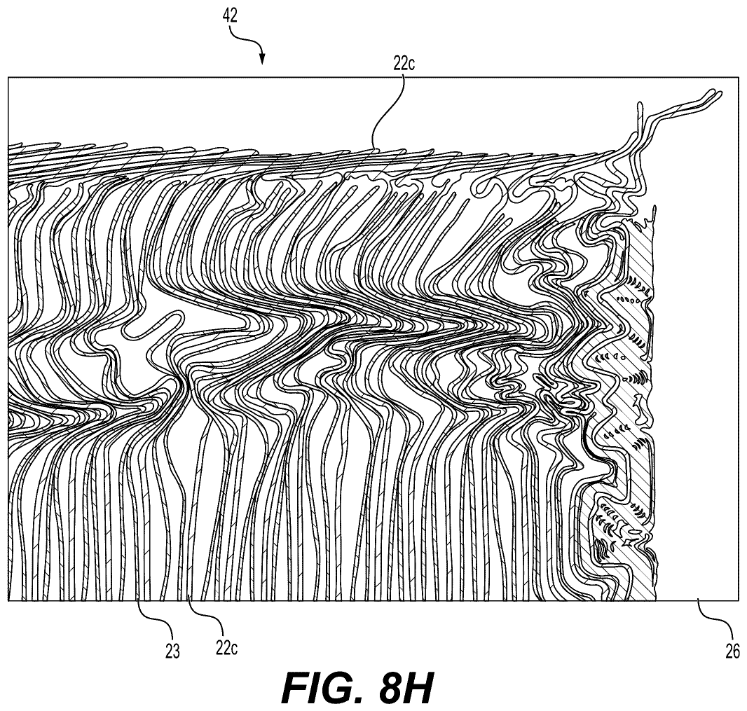

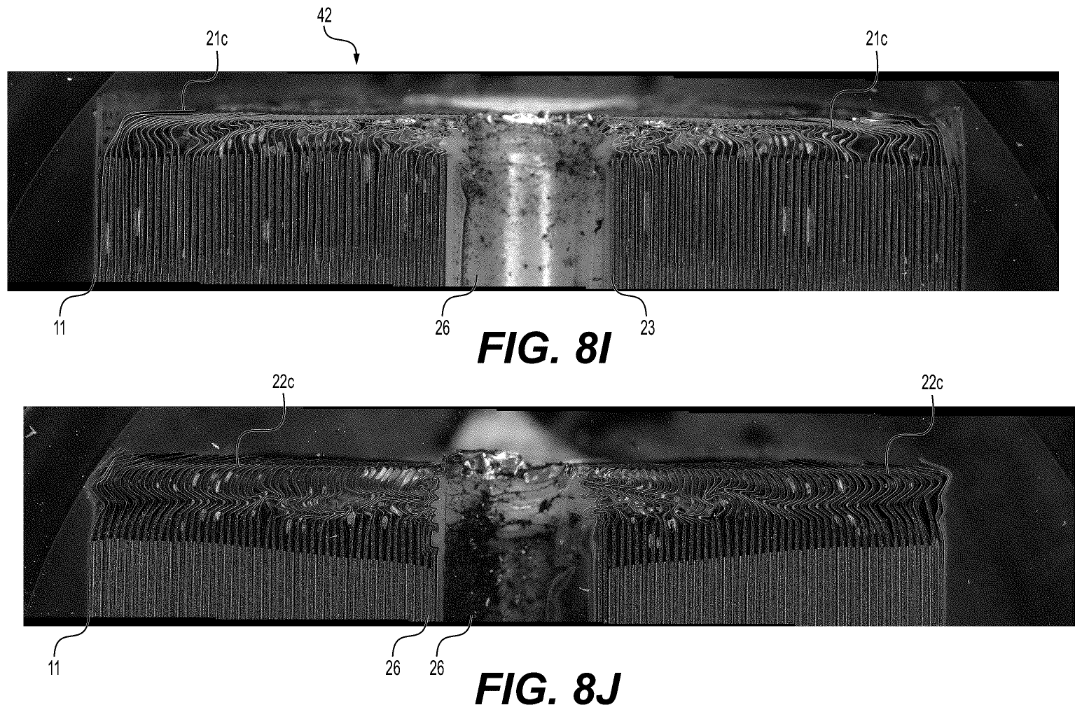

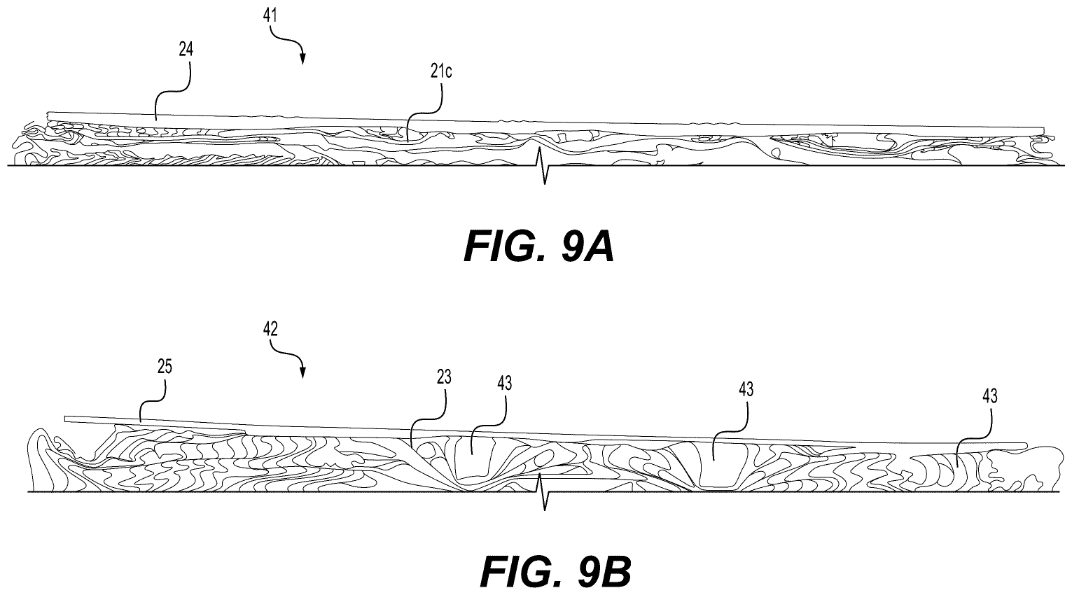

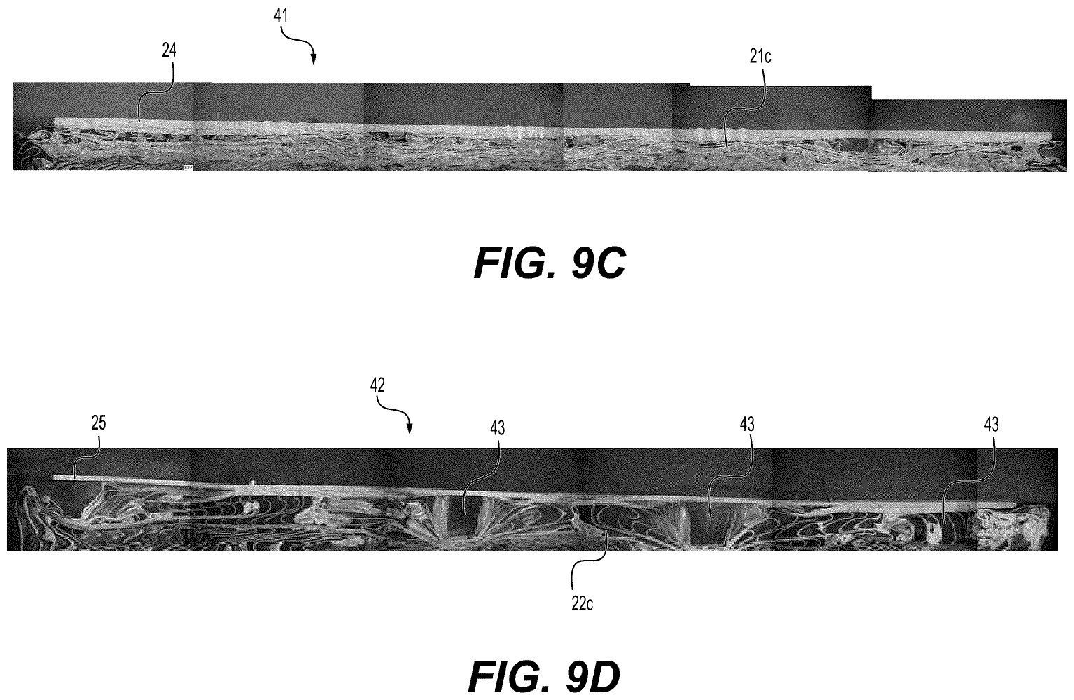

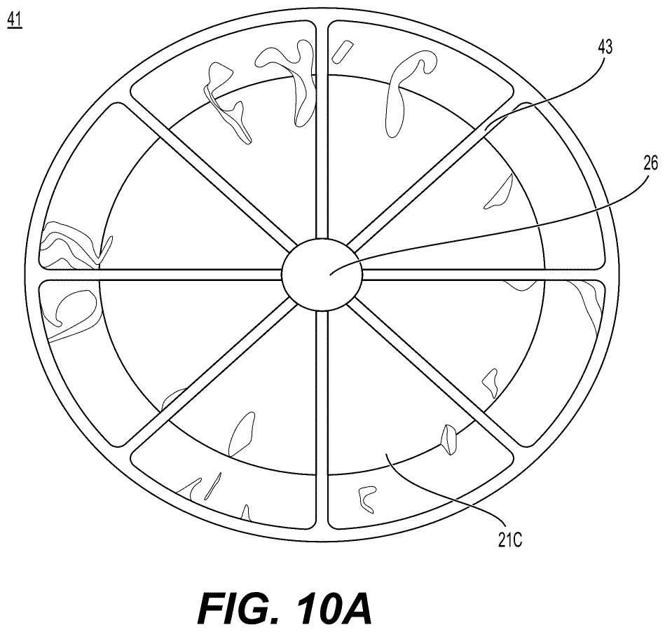

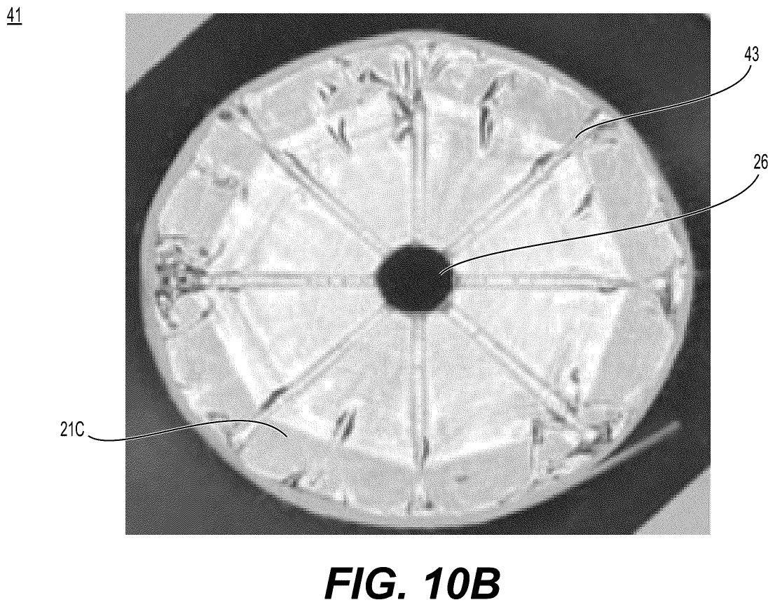

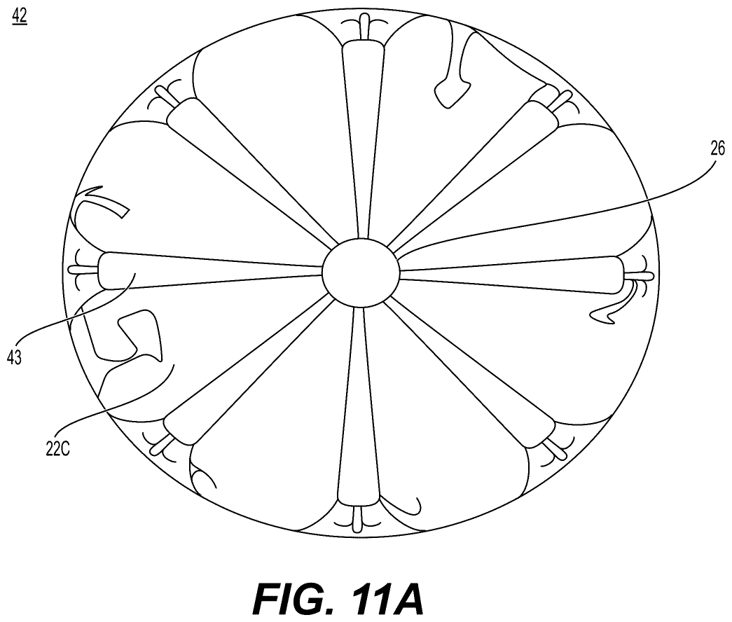

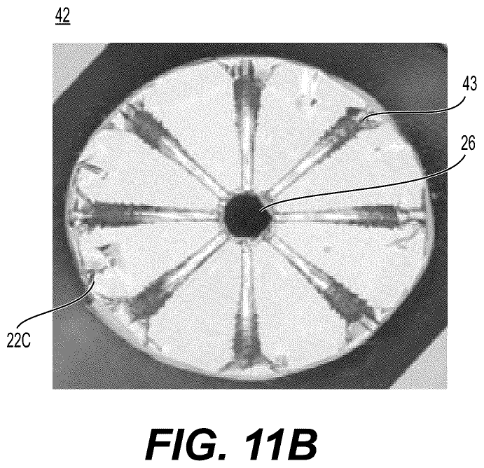

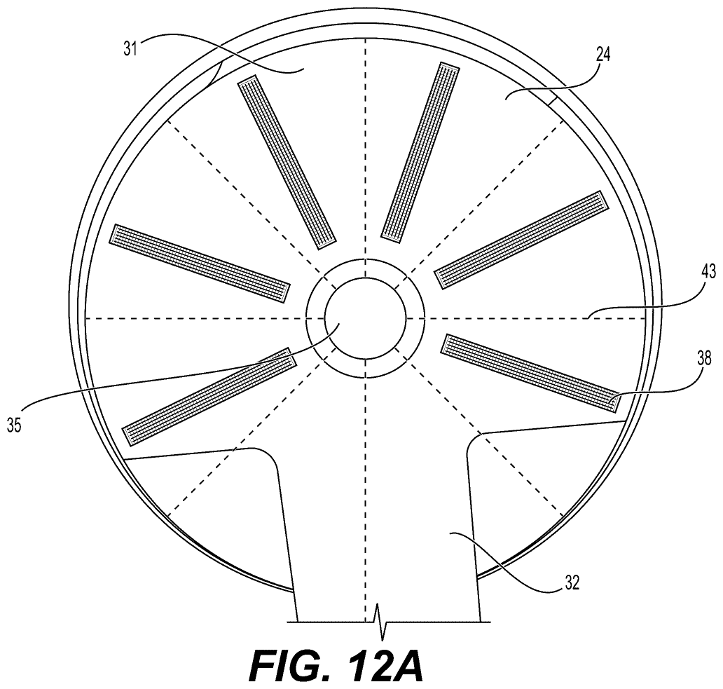

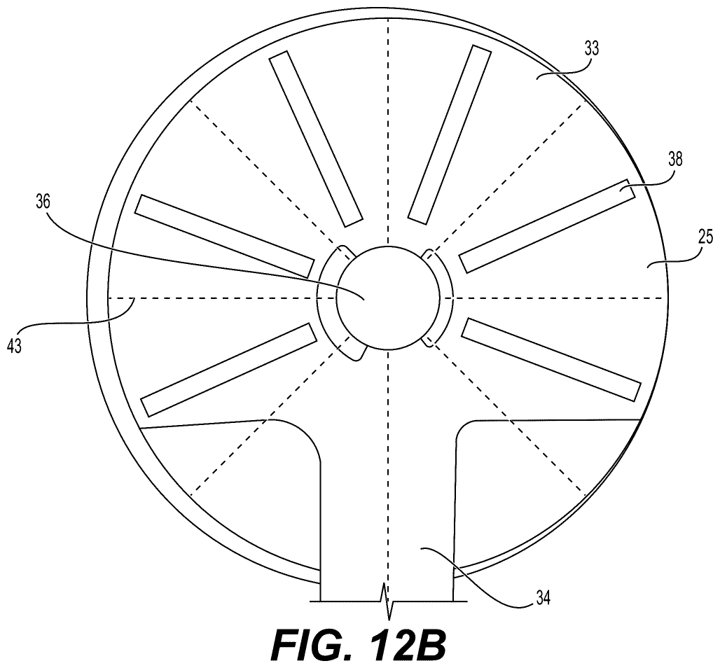

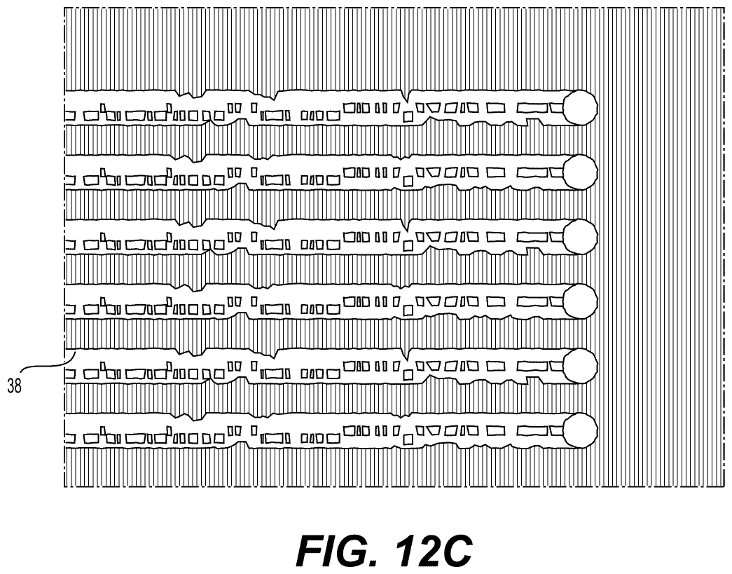

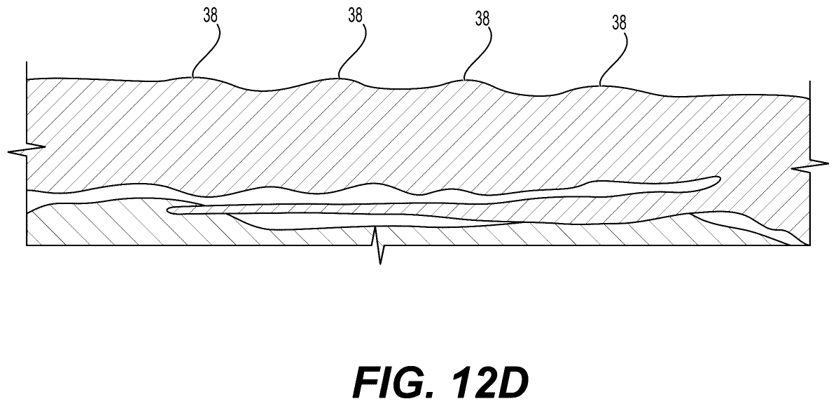

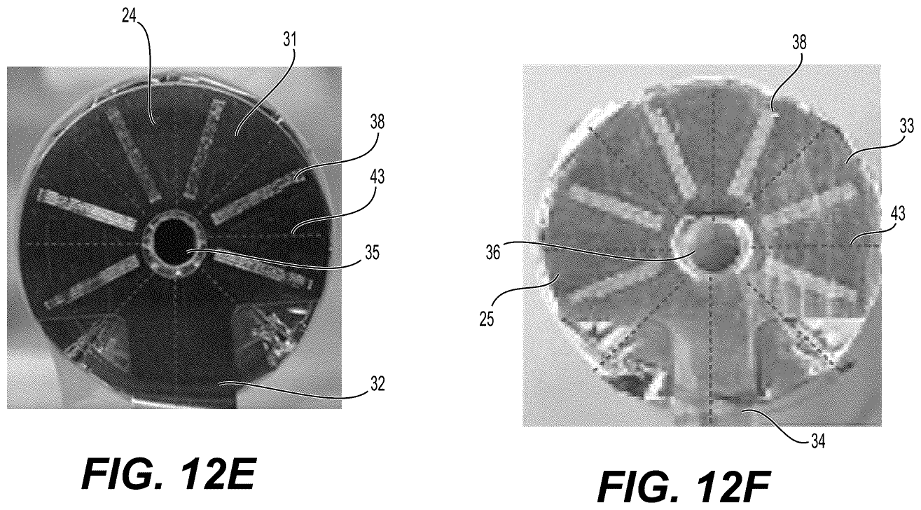

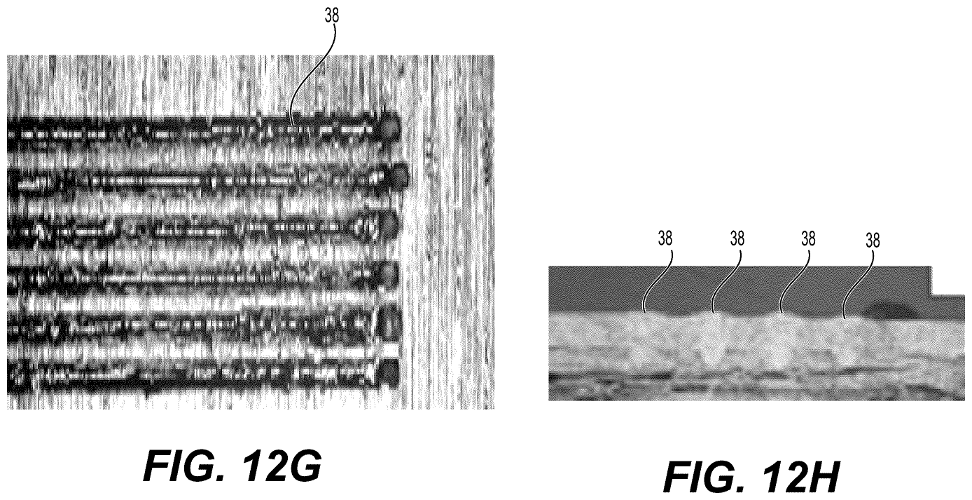

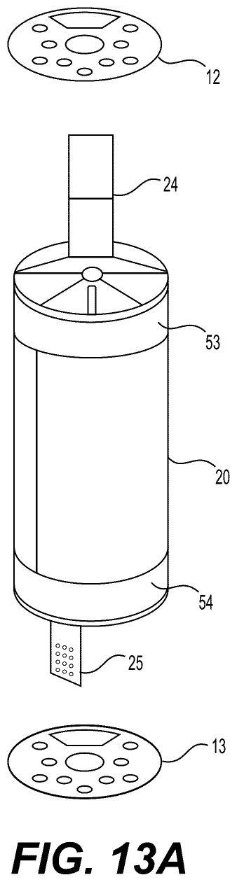

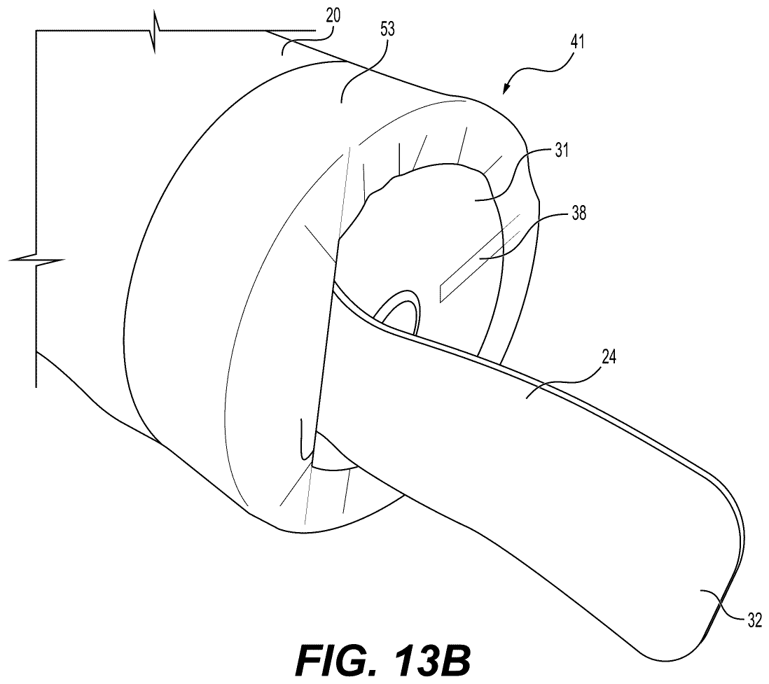

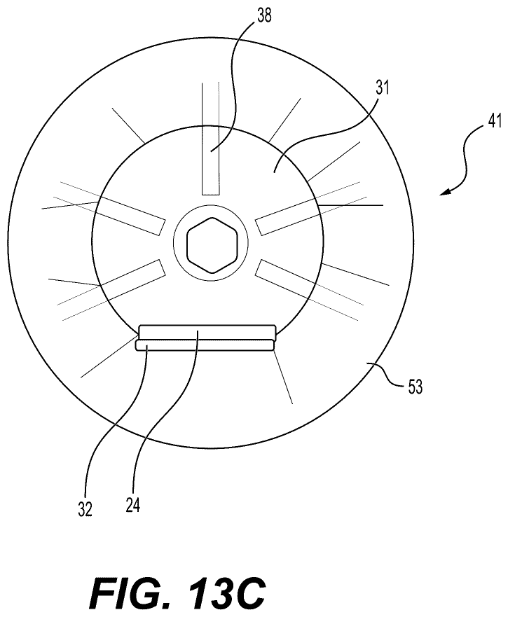

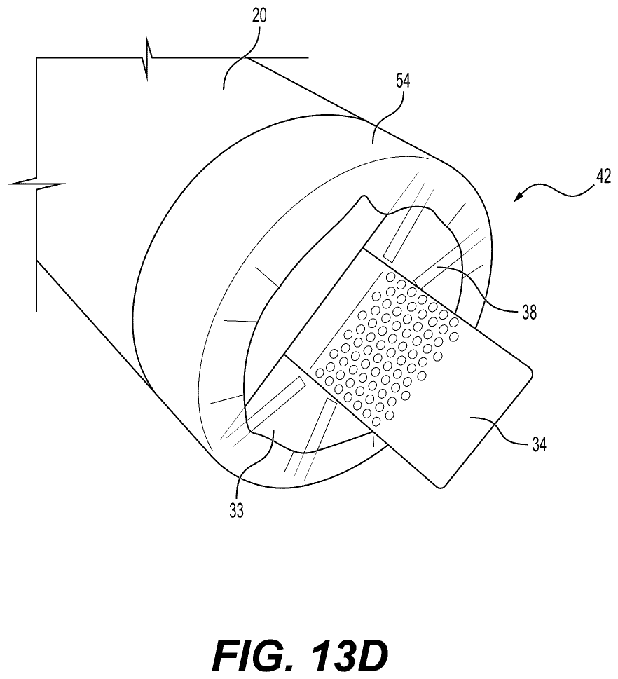

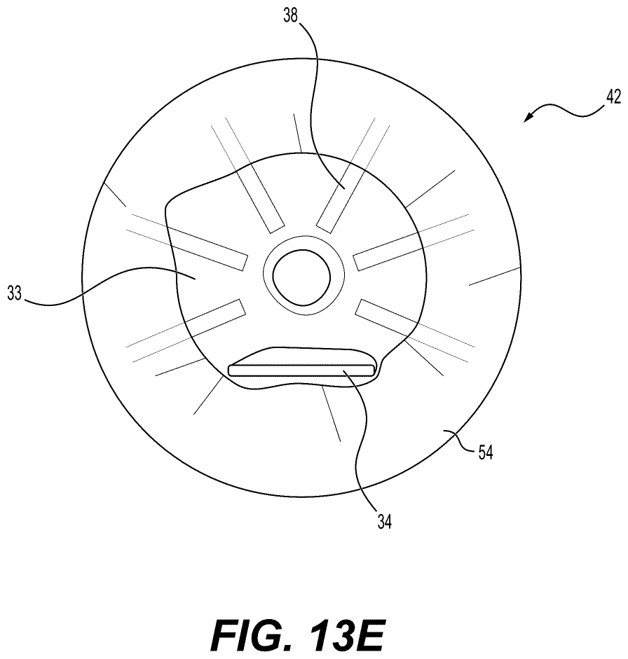

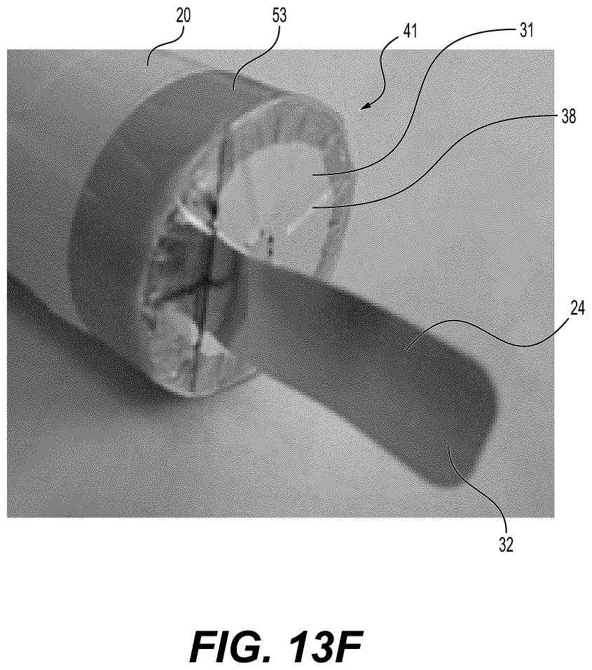

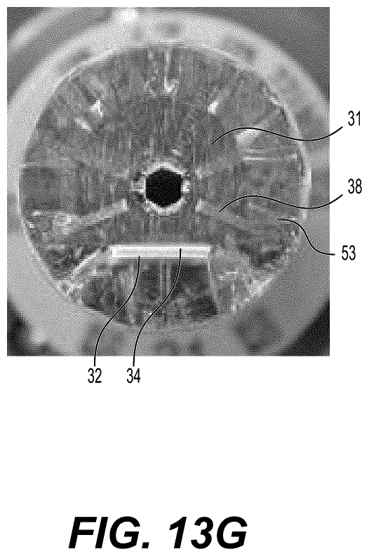

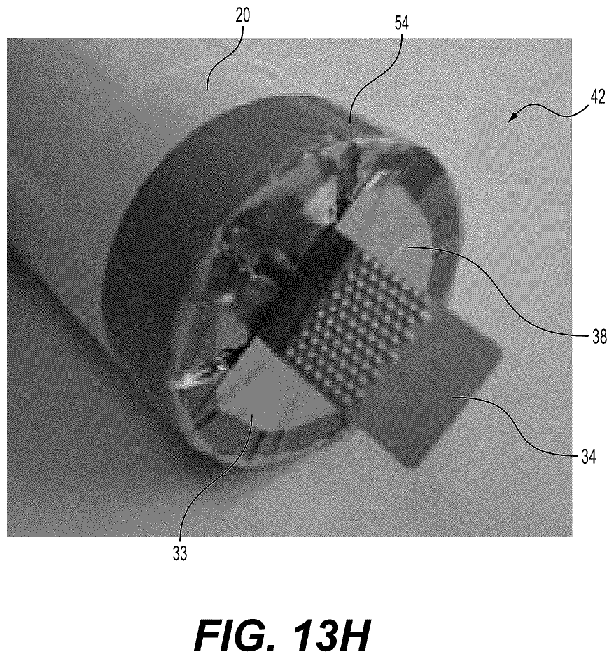

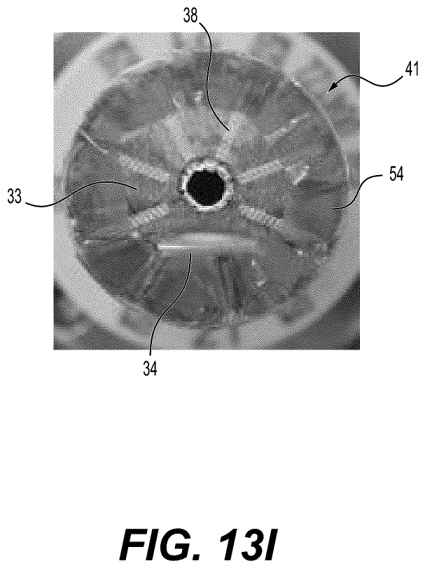

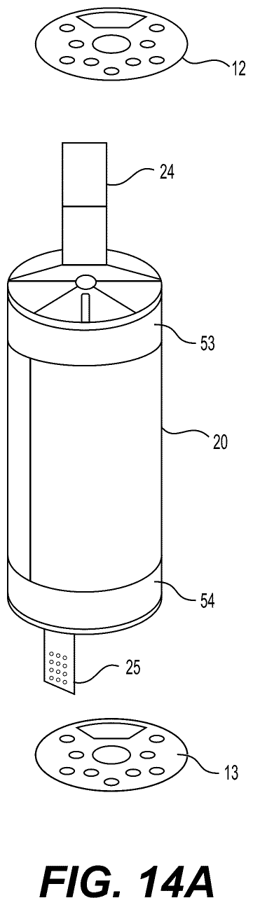

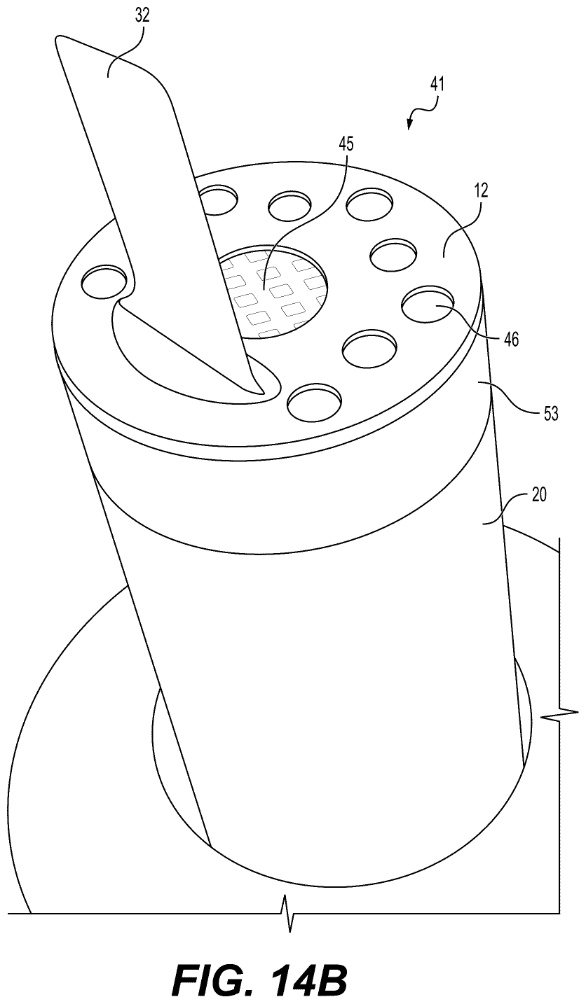

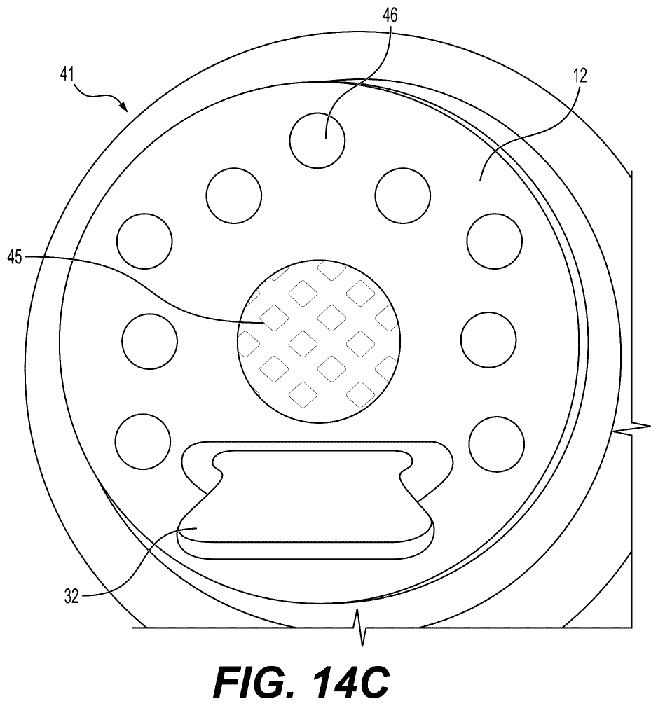

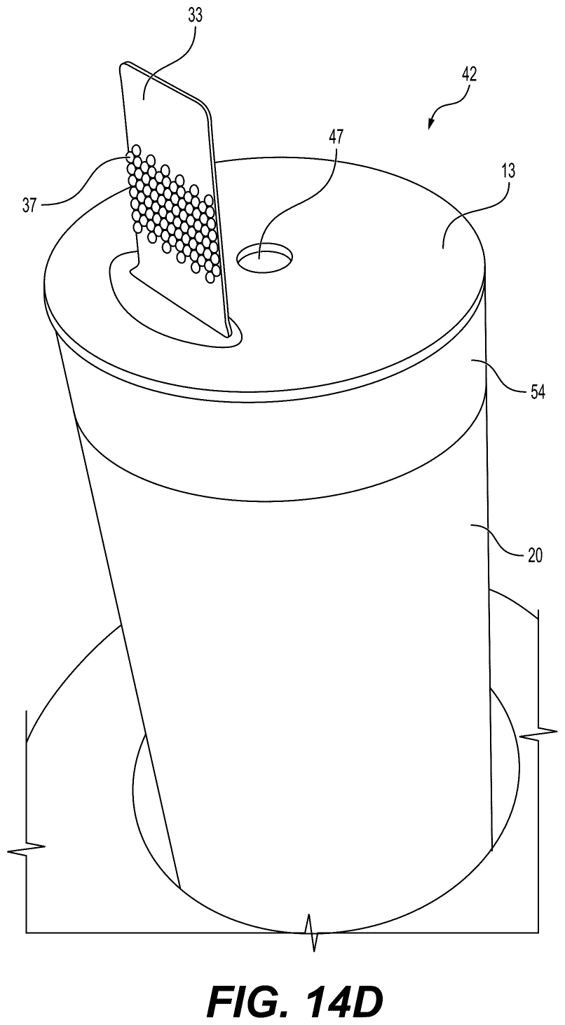

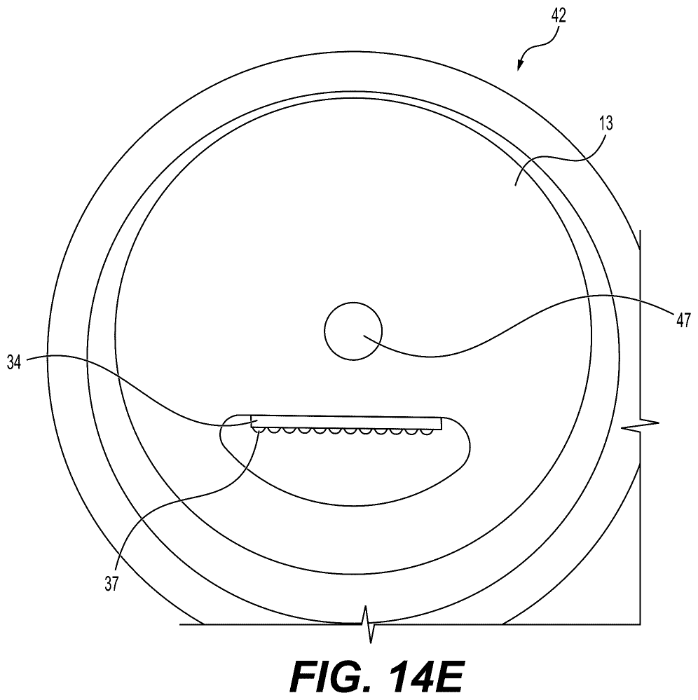

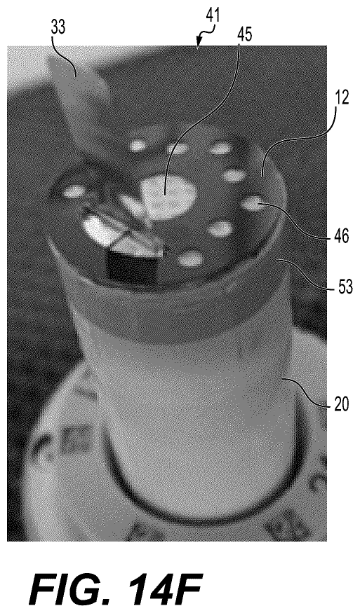

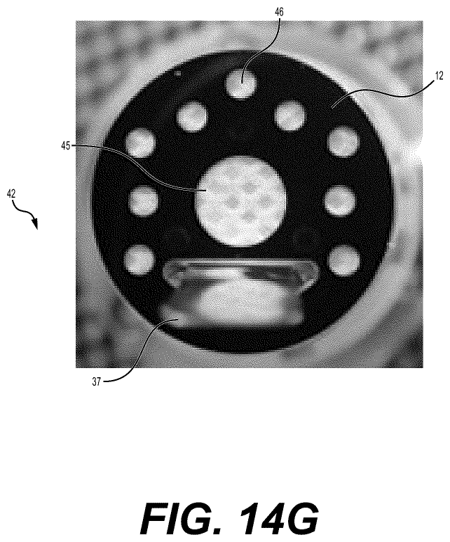

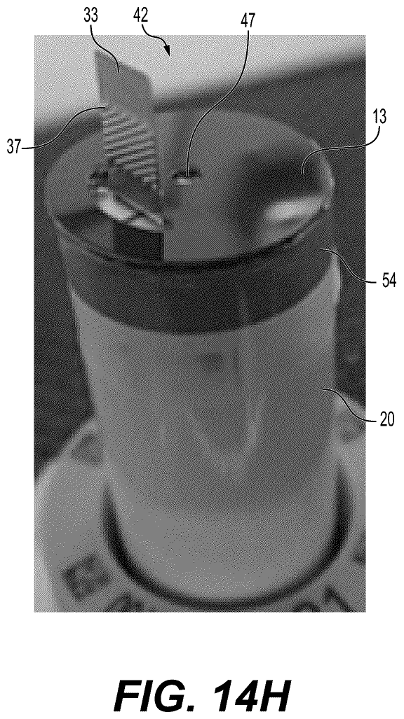

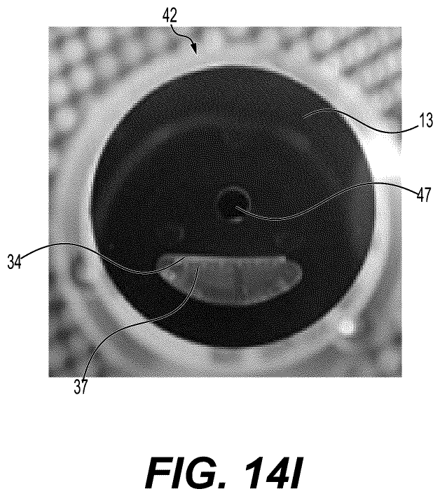

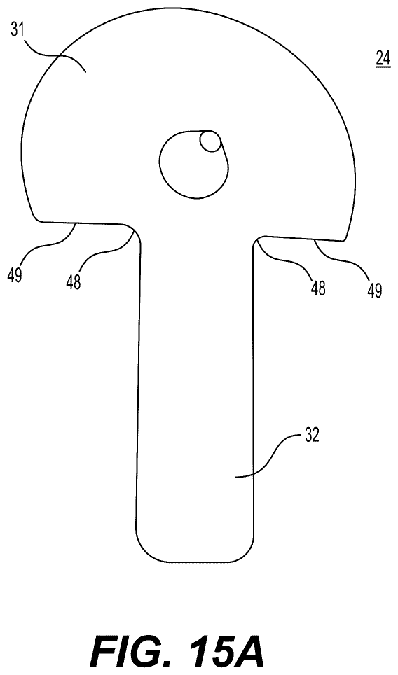

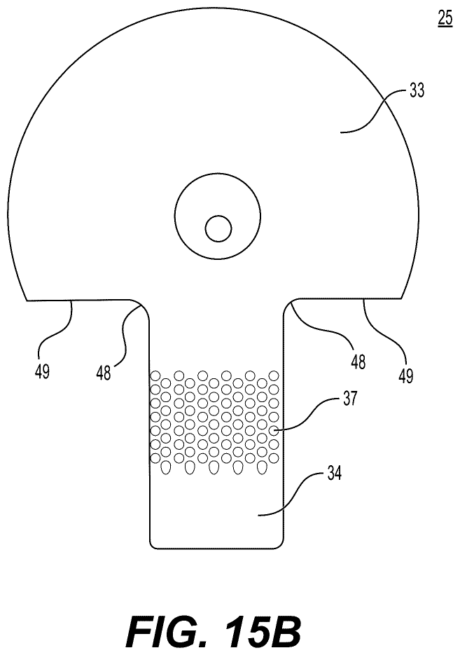

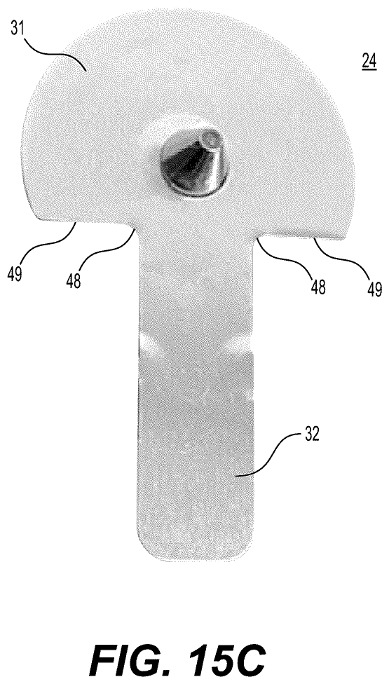

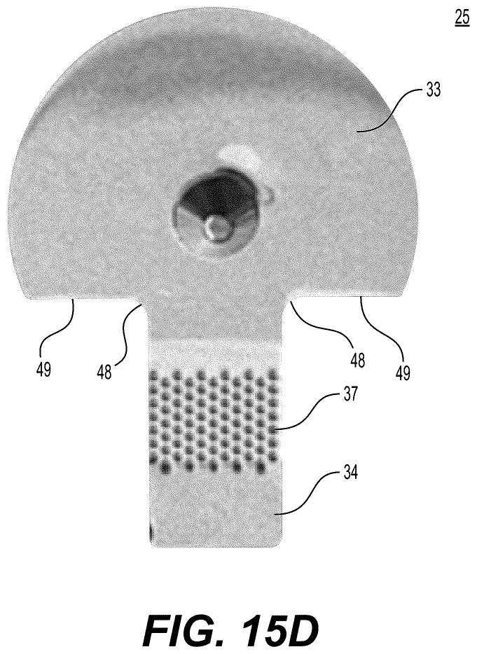

FIG. 7J is a photograph corresponding to FIG. 7E.

FIG. 8A is a schematic drawing of a cross-section of the positive side of a battery including the positive foil extension but not along the grooves in the positive foil extension.

FIGS. 8B-8D are closeup trace drawings of a photograph of portions of FIG. 8A.

FIG. 8E is a schematic drawing of a cross-section of the negative side of a battery including the negative foil extension but not along the grooves in the negative foil extension.

FIGS. 8F-8H are closeup trace drawings of a photograph of portions of FIG. 8E.

FIG. 8l is a photograph corresponding to FIG. 8A.

FIG. 8J is a photograph corresponding to FIG. 8E.

FIG. 9A is schematic drawing of a cross-section of the positive side of a battery crossing weld lines joining the positive foil extension with the positive and electrode current-collecting plate and crossing several grooves in the positive foil extension.

FIG. 9B is a schematic drawing of a cross-section of the negative side of a battery crossing weld lines joining the negative foil extension with the negative electrode current-collecting plate and crossing several grooves in the negative foil extension.

FIG. 9C is a photograph corresponding to FIG. 9A.

FIG. 9D is a photograph corresponding to FIG. 9B.

FIG. 10A is a schematic drawing of the positive end of a battery including the positive foil extension.

FIG. 10B is a photograph corresponding to FIG. 10A.

FIG. 11A is a schematic drawing of the negative end of a battery including the negative foil extension.

FIG. 11B is a photograph corresponding to FIG. 11A.

FIG. 12A is a schematic drawing of the positive end of a battery showing weld lines in the positive electrode current-collecting plate.

FIG. 12B is a schematic drawing of the negative end of a battery showing weld lines in the positive negative electrode current-collecting plate.

FIG. 12C is a close-up schematic drawing of the weld lines in the positive electrode current-collecting plate of FIG. 12A.

FIG. 12D is a cross-sectional schematic drawing of the weld lines in the positive electrode current-collecting plate of FIG. 12A.

FIGS. 12E-12H are photographs corresponding to FIG. 12A-12D.

FIG. 13A is a schematic drawing of the insulators on both ends of an electrode wound body.

FIGS. 13B and 13C are schematic drawings of the insulator on the positive end of the electrode would body.

FIGS. 13D and 13E are schematic drawings of the insulator on the negative end of the electrode would body.

FIGS. 13F-13I are photographs corresponding to FIGS. 13B-13E.

FIG. 14A is a schematic drawing of the positive and negative insulating plates on the ends of the electrode wound body.

FIGS. 14B and 14C are schematic drawings of the positive insulating plate on the positive end of the electrode wound body.

FIGS. 14D and 14E are schematic drawings of the negative insulating plate on the negative end of the electrode wound body.

FIGS. 14F-14I are photographs corresponding to FIGS. 14B-14E.

FIG. 15A is a schematic drawing of the positive current collector on the positive end of the electrode would body.

FIG. 15B is a schematic drawing of the negative current collector on the negative end of the electrode would body.

FIGS. 15C and 15D are photographs corresponding to FIGS. 15A and 15B.

### DETAILED DESCRIPTION OF EXAMPLE EMBODIMENTS

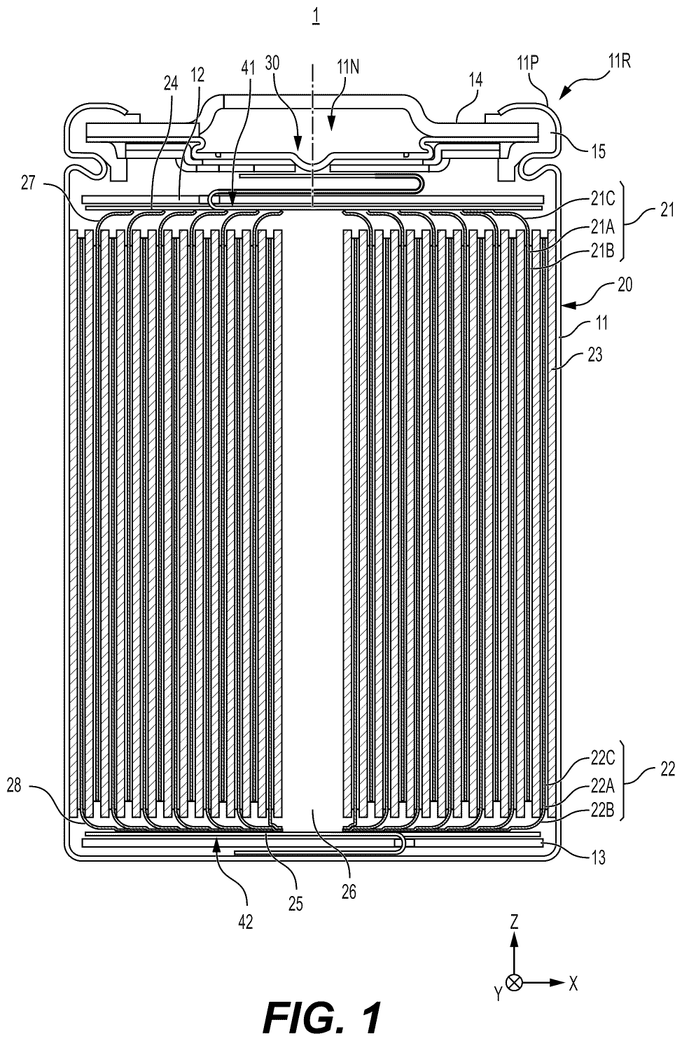

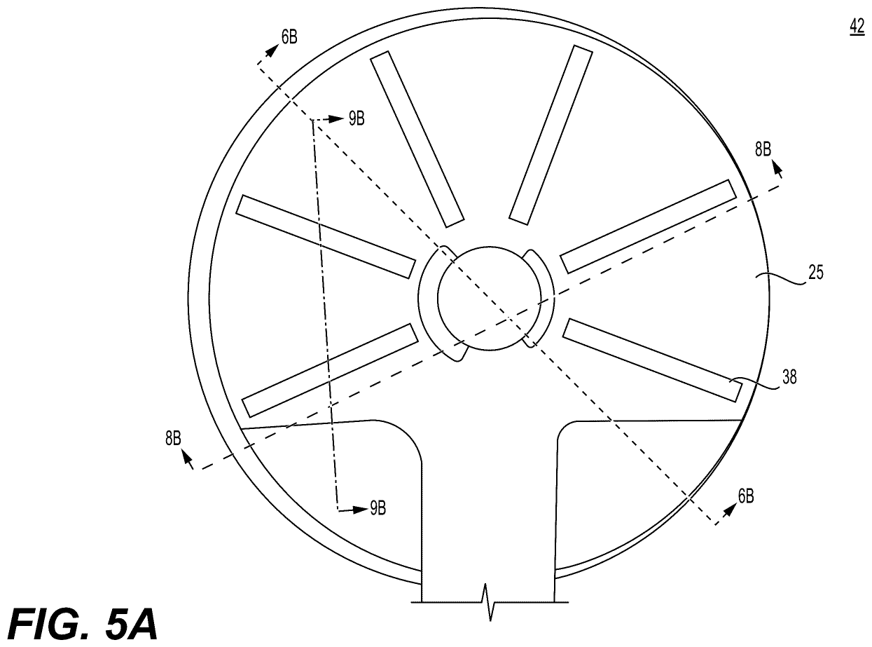

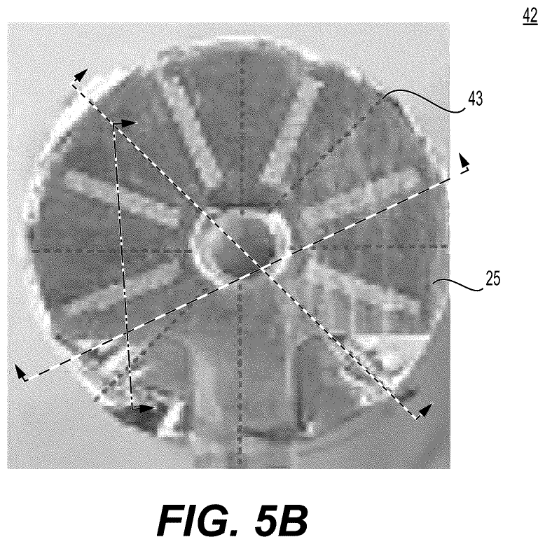

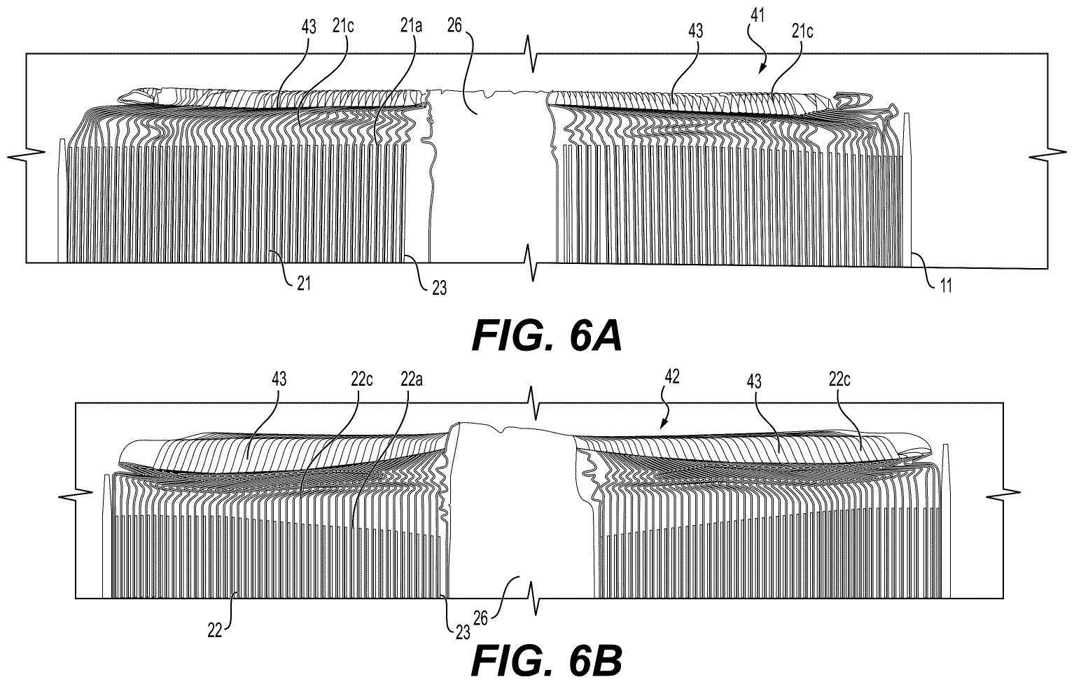

FIG. 1 is a schematic sectional view of a battery 1. FIGS. 5A-13I include schematic drawings and pictures of batteries corresponding to the battery 1 of FIG. 1.

The battery 1 can be a secondary battery, including, for example, a cylindrical lithium-ion battery. A battery other than a lithium-ion battery or a battery that has any shape other than a cylindrical shape can be also used.

The battery 1 can include an electrode wound body 20 housed inside an exterior can 11 as shown in FIG. 1. Specifically, the battery 1 includes, for example, a pair of insulating plates 12 and 13 and an electrode wound body 20 inside the cylindrical exterior can 11. The battery 1 can also include, for example, any one of or two or more of a positive temperature coefficient (PTC) element, a reinforcing member, and the like inside the exterior can 11.

The exterior can 11 houses the electrode wound body 20. The exterior can 11 can be a cylindrical container with an open end and a closed end. That is, the exterior can 11 can include an open end 11N. The exterior can 11 can contain, for example, any one of or two or more of metal materials such as iron, aluminum, and alloys thereof. The surface of the exterior can 11 can be plated with, for example, any one of or two or more of metal materials such as nickel.

Each of the insulating plates 12 and 13 can be, for example, a dish-shaped plate that has a surface perpendicular or substantially perpendicular within manufacturing and/or measurement tolerances to the winding axis of the electrode wound body 20, that is, a surface perpendicular or substantially perpendicular within manufacturing and/or measurement tolerances to the Z axis in FIG. 1. In addition, the insulating plates 12 and 13 can sandwich the electrode wound body 20 therebetween.

The open end 11N of the exterior can 11 can include, for example, a battery cover 14 and a safety valve 30 crimped with a gasket 15. The battery cover 14 serves as a “cover member,” and the gasket 15 serves as a “sealing member.” Thus, with the electrode wound body 20 and the like, housed inside the exterior can 11, the exterior can 11 is sealed. Accordingly, the open end 11N of the exterior can 11 includes a crimped structure (crimped structure 11R) formed by the battery cover 14 and the safety valve 30 crimped with the gasket 15. More specifically, a bent portion 11P is a so-called crimp portion, and the crimped structure 11R is a so-called crimp structure.

The battery cover 14 closes the open end 11N of the exterior can 11 mainly with the electrode wound body 20 and the like housed inside the exterior can 11. The battery cover 14 can contain, for example, the same material as the material that forms the exterior can 11. The central region of the battery cover 14 protrudes in the +Z direction, for example. Thus, the region (peripheral region) of the battery cover 14 other than the central region has contact with, for example, the safety valve 30.

The gasket 15 can be mainly interposed between the exterior can 11 (bent portion 11P) and the battery cover 14 to seal the gap between the bent portion 11P and the battery cover 14. For example, asphalt or the like can be, however, applied to the surface of the gasket 15.

The gasket 15 contains, for example, any one of or two or more of insulating materials. The types of the insulating materials are not particularly limited, and can be, for example, a polymer material such as a polybutylene terephthalate (PBT) and a polypropylene (PP). In particular, the insulating material can be a polybutylene terephthalate. This is because the gap between the bent portion 11P and the battery cover 14 is sufficiently sealed, while the exterior can 11 and the battery cover 14 are electrically separated from each other.

The safety valve 30 mainly releases the sealed state of the exterior can 11 to release the pressure (internal pressure) inside the exterior can 11, if necessary, when the internal pressure is increased. The cause of the increase in the internal pressure of exterior can 11 is, for example, a gas generated due to a decomposition reaction of an electrolytic solution during charging or discharging.

For the battery 1, a band-shaped positive electrode 21 and a band-shaped negative electrode 22 are spirally wound with a separator 23 interposed therebetween, impregnated with an electrolytic solution, and housed in the exterior can 11. The positive electrode 21 can be obtained by forming a positive electrode active material layer 21B on a portion of one or both surfaces of a positive electrode foil 21A, and the material of the positive electrode foil 21A can include, for example, a metal foil made of aluminum or an aluminum alloy. For example, the positive electrode foil 21 can be an aluminum foil with a thickness of approximately 12 μm within manufacturing and/or measurement tolerances. The negative electrode 22 can be obtained by forming a negative electrode active material layer 22B on a portion of one or both surfaces of a negative electrode foil 22A, and the material of the negative electrode foil 22A can be, for example, a metal foil made of nickel, a nickel alloy, copper, or a copper alloy. For example, the negative electrode foil 22 can be a copper foil with a thickness of approximately 8 μm within manufacturing and/or measurement tolerances. The separator 23 can include a porous and insulating film, which enables transfer of substances such as ions and an electrolytic solution, while electrically insulating the positive electrode 21 and the negative electrode 22.

The positive electrode active material layer 21B and the negative electrode active material layer 22B respectively cover most of the positive electrode foil 21A and the negative electrode foil 22A, but intentionally, neither of the layers covers one end periphery in the short axis direction of the band. The portion of the positive or negative electrode foil 21 or 22 that extends from the positive or negative electrode foil 21 or 22 but is not covered with positive or negative electrode active material layer 21B or 22B is referred to as a positive or negative foil extension 21c or 22c. In the battery 1, the electrode wound body 20 is wound to define a through hole 26 with a central axis.

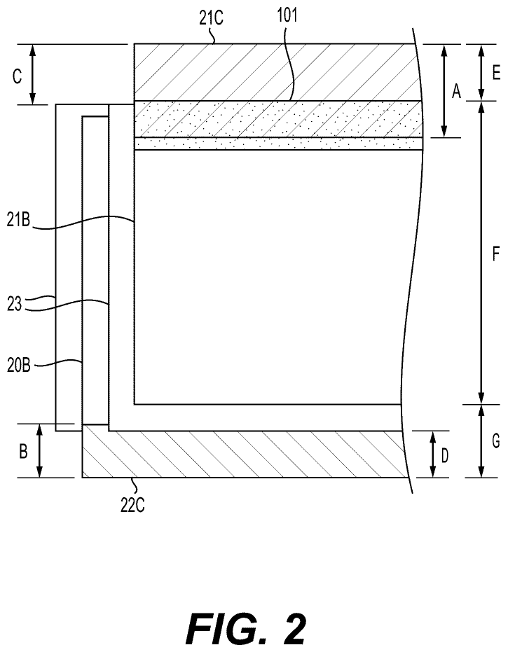

FIG. 2 shows an example of a structure with the positive electrode 21, the negative electrode 22, and the separator 23 stacked before winding. The positive foil extension 21C (the upper hatched portion in FIG. 2) of the positive electrode 21 has a width denoted by A, and the negative foil extension 22C (the lower hatched portion in FIG. 2) of the negative electrode 22 has a width denoted by B. The relationship A>B can be satisfied, with, for example, A=7 mm and B=4 mm, but other dimensions are also possible. A portion of the positive foil extension 21C of the positive electrode 21, protruding from one end of the separator 23 in the width direction, has a length denoted by C, and a portion of the negative foil extension 22C of the negative electrode 22, protruding from the other end of the separator 23 in the width direction, has a length denoted by D. The relationship C>D can be satisfied, with, for example, C=4.5 mm and D=3 mm, but other dimensions are also possible. The complete stack of the positive electrode 21, the negative electrode 22, and the separator 23 can have a width denoted by G. The length of the positive foil extension 21C that extends from the complete stack can be denoted by E, and the length of the negative foil extension 22C that extends from the complete stack can be denoted by F. The relationship E<F can be satisfied, with, for example, E=3.5 mm and F=4.5 mm, but other dimensions are also possible.

The positive foil extension 21C of the positive electrode 21 can be made of, for example, aluminum, whereas the negative foil extension 22C of the negative electrode 22 can be made of, for example, copper, and thus, the positive foil extension 21C of the positive electrode 21 is typically softer (has a lower Young's modulus) than the negative foil extension 22C of the negative electrode 22. Thus, the relationships A>B and C>D can be satisfied, and when the positive foil extension 21C of the positive electrode 21 and the negative foil extension 22C of the negative electrode 22 are bent at the same pressure simultaneously from both sides, the positive electrode 21 and the negative electrode 22 can be similar in height of the bent portions, measured from the ends of the separator 23. The positive foil extension 21C can be bent so that bends in radially adjacent portions of the positive foil extension 21C overlap, thus allowing the positive foil extension 21C and the current-collecting plate 24 to be easily joined. And the negative foil extension 22C can be bent so that bends in radially adjacent portions of the negative foil extension 21C overlap, thus allowing the negative foil extension 22C and the current-collecting plate 25 to be easily joined. Joining can mean joining by laser welding, but the joining method is not limited to laser welding. The shape of the different bends in the positive foil extension 21C can be different, and the shape of the different bends in the negative foil extension 22C can be different. For example, the shapes of the bends in the positive foil extension 21C can be asymmetric about the central axis through the through hole 26, and the shapes of the bends in the negative foil extension 22C can be asymmetric about the central axis through the through hole 26. When the positive and negative foil extensions 21C, 22C are bent, it is possible that the separator 23 can be bent. It is also possible that, when the positive and negative foil extensions 21C, 22C are bent, the positive and/or negative active material layers 21B, 22B can be bent.

For the positive electrode 21, a section of about 3 mm in width within manufacturing and/or measurement tolerances, including the boundary between the positive foil extension 21C and the positive electrode active material layer 21B, is coated with an insulating layer 101 (gray region portion in FIG. 2). Further, the whole region of the positive foil extension 21C of the positive electrode 21, opposed to the negative electrode active material layer 22B of the negative electrode 22 with the separator 23 interposed therebetween, is covered with the insulating layer 101. The insulating layer 101 has the effect of reliably preventing any internal short circuit of the battery 1 if any foreign matter enters between the negative electrode active material layer 22B of the negative electrode 22 and the positive foil extension 21C of the positive electrode 21. In addition, the insulating layer 101 has the effect of, when an impact is applied to the battery 1, absorbing the impact and reliably preventing the positive foil extension 21C of the positive electrode 21 from being bent or short-circuited with the negative electrode 22.

The central axis of the electrode wound body 20 extends through the through hole 26. The through hole 26 is a hole through which a winding core and a welding electrode rod can be inserted. The electrode wound body 20 is wound in an overlapping manner such that the positive foil extension 21C of the positive electrode 21 and the negative foil extension 22C of the negative electrode 22 extend from the electrode wound body 20 in the opposite directions, and thus, the positive foil extension 21C of the positive electrode 21 is located at end 41 of the electrode wound body 20, while the negative foil extension 22C of the negative electrode 22 is located at end 42 of the electrode wound body 20. To improve contact with the current-collecting plates 24 and 25 for current extraction, the positive and negative foil extensions 21C and 22C can be bent so that the ends 41 and 42 can define substantially flat surfaces within manufacturing tolerances. The bending directions are directions from the outer edges 27 and 28 of the ends 41 and 42 toward the through hole 26, and peripheral positive and negative foil extensions 21C or 22C that are adjacent in the wound state are bent in a manner to overlap with each other to define a substantially smooth surface within manufacturing tolerances with a glossy appearance. The specular glossiness Gs (60°) of the substantially smooth surface can be measured in accordance with JIS Z 8741:1997, where the incident angle of light is 60°. For example, the specular glossiness Gs (60°) of a glass surface with a refractive index of 1.567 is 100. The surface can define a substantially flat surface or a surface with a raised portion or portions. In any case, the surface can be a substantially smooth surface to the extent that the joint to the current-collecting plate 24 or 25 is not affected if the surface has some unevenness.

The positive foil extension 21C can be bent so that bends in portions of the positive foil extension 21C overlap so that the end 41 can define a flat surface. And the negative foil extension 22C can be bent so that bends in portions of the negative foil extension 22C overlap so that the end 42 can define a flat surface. Bending the positive and negative foil extensions 21C, 22C can create bends, folds, wrinkles, voids, or cavities at the ends 41 and 42. For example, FIGS. 7B and 7H show cavities 44 between folds of the positive and negative foil extensions 21C, 22C that bend in the opposite directions. The number of bends, folds, or wrinkles in the positive foil 21A can be greater than the number of bends, folds, or wrinkles in the negative foil 22A, for example, if the positive foil 21A is softer (i.e., has a lower Young's modulus) than the negative foil 22A and/or if the length of the positive foil extension 21C from the complete stack is shorter than the length of the negative foil extension 22C from the complete stack.

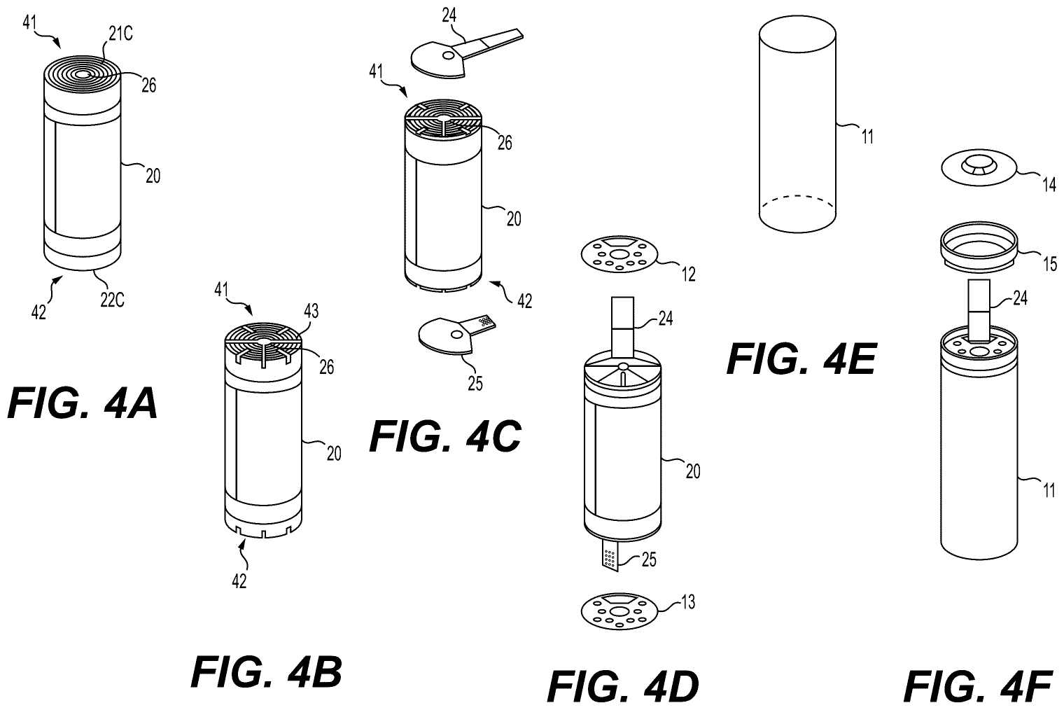

Grooves 43 (see, for example, FIG. 4B) can be formed in the radial direction of the electrode wound body 20 with the center being the through hole 26. The groove 43 can extend from the outer edges 27 and 28 of the ends 41 and 42 to the through hole 26. The central axis of the electrode wound body 20 extends through the through hole 26, and the through hole 26 is used as a hole into which a welding tool can be inserted in assembling the battery 1. If the grooves are formed in the flat surfaces before bending the positive and negative foil extensions 21C and 22C, the grooves 43 can remain in the flat surfaces after bending the positive and negative foil extensions 21C and 22C, and portions without the grooves 43 can be joined (welded or the like) to the positive electrode current-collecting plate 24 or the negative electrode current-collecting plate 25. The grooves 43 as well as the flat surfaces can be joined to a portion of the positive or negative electrode current-collecting plates 24 or 25.

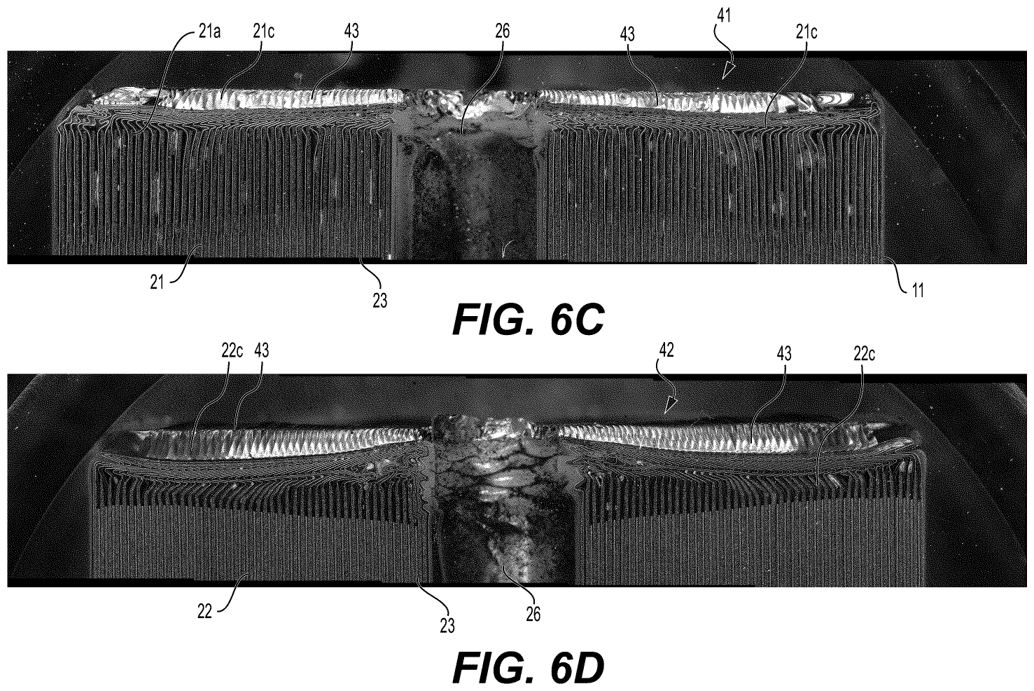

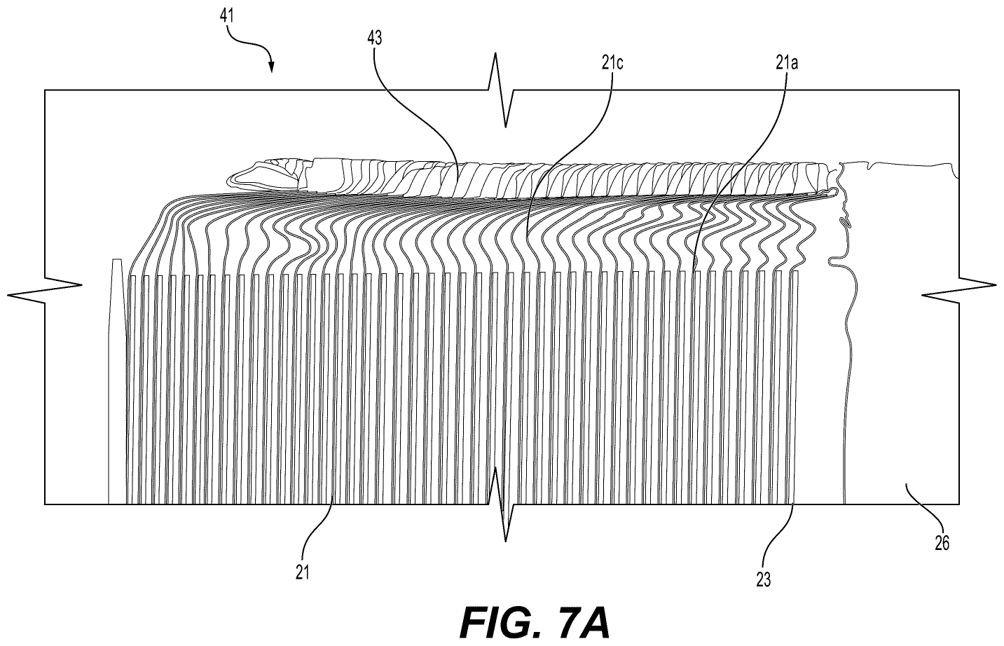

FIGS. 5A and 5B show the negative side of a battery corresponding to the battery 1 shown in the schematic view of FIG. 1. FIGS. 5A and 5B show the lines of the cross-sectional views of FIGS. 6A-9D. FIGS. 5A and 5B show the battery 1 with the negative electrode current-collecting plate 25 that covers the grooves 43.

FIGS. 6A-6D show the positive and negative sides of a battery 1 along the grooves 43 in the positive and negative foil extensions 21C, 22C. FIGS. 6A-6D show that the bottom of the grooves 43 can be curved and that the grooves 43 on the negative side can be deeper than the grooves 43 on the positive side. As shown in FIGS. 6A and 6C, the groove 43 on the positive side of the battery 1 can be approximately 0.4 mm within manufacturing and/or measurement tolerances, but other values are also possible. And, as shown in FIGS. 6B and 6D, the groove 43 on the negative side of the battery 1 can be approximately 0.8 mm within manufacturing and/or measurement tolerances, but other values are also possible. The bending shape of the positive and negative foil extensions 21C, 22C can be asymmetric with respect to the central axis extending through the through hole 26.

FIGS. 7A-7J show close-up views of the positive and negative sides of the battery 1 along the grooves 43 in the positive and negative foil extensions 21C, 22C. As shown in FIGS. 7A-7J, the positive and negative foil extensions 21C, 22C include bends, as described above. The process of creating the bends in the positive and negative foil extensions 21C, 22C can result in bends in the portions of the separator 23 near the positive and negative foil extensions 21C, 22C and can result in bends in the portions of the positive and negative electrode active material layers 21B, 22B near the positive and negative foil extensions 21C, 22C. Cavities or voids can be created between radially adjacent portions of the positive electrode foil 21A and between portions of the negative electrode foil 22A. A portion of the positive electrode foil 21A and/or a portion of the negative electrode foil 22A can be folded over the innermost portion of the separator 23 such that a portion of the positive electrode foil 21A and/or a portion of the negative electrode foil 22A just reaches the through hole 26. In some applications, a portion of the positive electrode foil 21A and/or a portion of the negative electrode foil 22A can be inside the through hole 26, but in other applications, no portion of the positive electrode foil 21A and no portion of the negative electrode foil 22A is inside the through hole 26. For example, if a fixing rod is inserted in the through hole 26 when the positive and negative foil extensions 21C, 22C are bent, the fixing rod can prevent the positive electrode foil 21A and/or the negative electrode foil 22A from being in the through hole 26.

FIGS. 8A-8J show cross-sections of the positive and negative sides of a battery 1 including the positive and negative foil extensions 21C, 22C but not along the grooves 43 in the positive and negative foil extensions 21C, 22C. FIGS. 8A-8D and 81 show that radially adjacent portions of the positive foil extension 21C can be closer together the further away from the negative active material layer 22B they are (i.e., the distance between radially adjacent portions of the positive foil extension 21C decreases as the distance to the negative active material layer 22B increases), and FIGS. 8E-8H and 8J that radially adjacent portions of the negative foil extension 22C can be closer together the further away from the positive active material layer 21B they are (i.e., the distance between radially adjacent portions of the negative foil extension 22C decreases as the distance from the positive active material layer 21B increases). In other words, FIGS. 8A-8D and 81 shows that radially adjacent portions of the positive foil extension 21C can be closer together the further away from a stack of the positive electrode 21, the separator 23, and the negative electrode 22 they are (i.e., the distance between radially adjacent portions of the positive foil extension 21C decreases as the distance to the stack of the positive electrode 21, the separator 23, and the negative electrode 22 increases), and FIGS. 8E-8H and 8J show that radially adjacent portions of the negative foil extension 22C can be closer together the further away from the stack of the positive electrode 21, the separator 23, and the negative electrode 22 they are (i.e., the distance between radially adjacent portions of the negative foil extension 22C decreases as the distance from the positive active material layer 21B increases). In addition, as shown in FIGS. 8A-8D and 81, radially adjacent portions of the positive foil extension 21C can be closer together the closer to the through hole 26 they are (i.e., the distance between radially adjacent portions of the positive foil extension 21C decreases as the distance to the through hole 26 decreases), and as shown in FIGS. 8E-8H and 8J, radially adjacent portions of the negative foil extension 22C can be closer together the closer to the through hole 26 they are (i.e., the distance between radially adjacent portions of the negative foil extension 22C decreases as the distance to the through hole 26 decreases). If the fitting degree includes the number of overlaps between radially adjacent portions, the length of an overlap of radially adjacent portions, and the number of times that radially adjacent portions are sandwiched together, then the fitting degree between radially adjacent portions of the positive foil extension 21C can increase closer to the through hole 26, as shown in FIGS. 8A-8D and 81, and then the fitting degree between radially adjacent portions of the negative foil extension 22C can increase closer to the through hole 26, as shown in FIGS. 8E-8H and 8J.

FIGS. 9A-9D show, after the positive or negative foil extensions 21C, 22C and the current-collecting plate 24 or 25 are welded, cross-sections of the positive and negative sides of a battery 1 crossing the weld lines and crossing several grooves 43. As shown in FIGS. 9B and 9D, the cross sections of the grooves 43 can have a rectangular shape, even after welding. If a softer metal (i.e., has a lower Young's modulus) is used for the positive or negative electrode foil 21A, 21B, then the grooves 43 can lose their shape during further processing of the battery 1. In FIGS. 9A and 9C, the positive side uses softer aluminum as the positive electrode foil 21A, which results in the grooves 43 in the positive electrode foil 21A being crushed and not retaining their shape so that the cross-sectional shape is no longer clear after welding. If a harder metal (i.e., has a higher Young's modulus) is used for the positive or negative electrode foil 21A, 21B, then the grooves 43 can retain their shape during further processing of the battery 1. In FIGS. 9B and 9D, the negative side uses harder copper as the negative electrode foil 22A, which results in the grooves 43 in the negative electrode foil 21A retaining their shape so that the cross-sectional shape is retained and clearly seen after welding.

FIGS. 10A and 10B show the positive end 41 of a battery 1 without the electrode current-collecting plate 24. FIGS. 11A and 11B show the negative end 42 of a battery 1 without the electrode current-collecting plate 25. FIGS. 10A and 10B show the end 41 of the battery 1 and after the grooves 43 have been created and after the positive foil extension 21C have been bent. FIGS. 11A and 11B show the end 42 of the battery 1 and after the grooves 43 have been created and after the negative foil extension 22C have been bent. As shown in FIGS. 10A-11B, the ends 41, 42 have a glossy appearance with the ends 41, 42 defining a substantially smooth surface within manufacturing tolerances.

FIGS. 12A and 12E show the positive electrode current-collecting plate 24 with weld lines, and FIGS. 12B and 12F show the negative electrode current-collecting plate with weld lines. The grooves 43 underneath the positive and negative electrode current-collecting plates 24, 25 are shown with broken lines. The weld lines can extend radially with the center being the central axis of the through hole 26. Each weld line can include two or more sub-lines. FIGS. 12C, 12D, 12G, and 12H show six sub-lines that extend parallel or substantially parallel within manufacturing and/or measurement tolerances, but any number of sub-lines can be used. Thus, multiple weld lines can be included between adjacent grooves 43.

In a known lithium-ion battery, for example, a current-extraction lead is welded to each of the positive electrode 21 and negative electrode 22, but this is not suitable for high-rate discharge because of the high internal resistance of the battery and the temperature increased by heat generation of the lithium-ion battery in the case of discharging. Thus, in the battery 1, the internal resistance of the battery can be kept low by disposing the positive electrode current collecting plate 24 and the negative electrode current collecting plate 25 at the ends 41 and 42, and welding at multiple points to the positive and negative foil extensions 21C and 22C at the ends 41 and 42. The ends 41 and 42 can be bent to define substantially flat surfaces within manufacturing tolerances, which also contributes to the reduction in resistance.

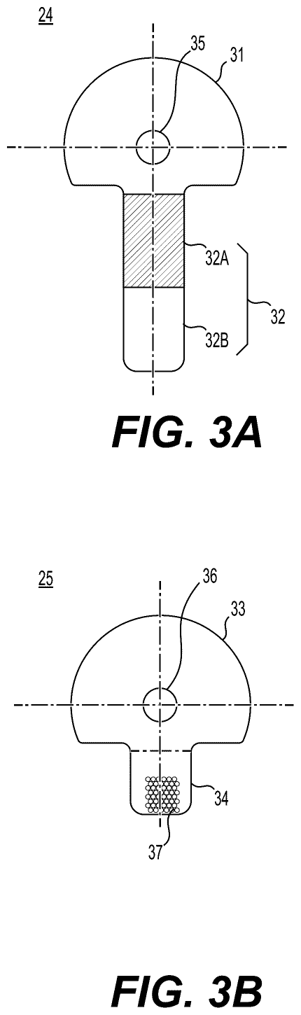

FIGS. 3A and 3B show examples of the current collecting plates 24, 25. FIG. 3A shows the positive electrode current-collecting plate 24, and FIG. 3B shows the negative electrode current-collecting plate 25. The material of the positive electrode current-collecting plate 24 can be, for example, a metal plate made of a simple substance of aluminum, an aluminum alloy, or a composite thereof, and the material of the negative electrode current-collecting plate 25 is, for example, a metal plate made of a simple substance of nickel, a nickel alloy, copper, a copper alloy, or a composite thereof. As shown in FIGS. 3A, 15A, and 15C, the positive electrode current-collecting plate 24 includes a flat fan-shaped portion 31 and a rectangular band-shaped portion 32. The flat fan-shaped portion 31 and the rectangular band-shaped portion 32 can be connected to define two corners 48. As shown in FIGS. 3A, 15A, and 15C, each of the two corners 48 can be curved. The fan-shaped portion 31 includes, near the center thereof, a hole 35, and the hole 35 is located at a position corresponding to the through hole 26 so the hole 35 is aligned with the through hole 26. The fan-shaped portion 31 includes a curved portion and two straight-line portions. As shown in FIGS. 3A, 15A, and 15C, the lines 49 of the two straight-line portions can be co-linear or substantially co-linear within manufacturing and/or measurement tolerances. A hatched portion in FIG. 3A is an insulating portion 32A where an insulating tape is attached to the band-shaped portion 32 or an insulating material is applied thereto, and the portion below the hatched portion is a connecting portion 32B to a sealing plate that also serves as an external terminal. In a battery structure without any metallic center pin (not shown) in the through hole 26, the band-shaped portion 32 has a low probability of coming into contact with a site with a negative electrode potential, and thus, there is no need for the insulating portion 32A. In such a case, the widths of the positive electrode 21 and negative electrode 22 can be increased by an amount corresponding to the thickness of the insulating portion 32A to increase the charge/discharge capacity.

The negative electrode current collecting plate 25 has substantially the same shape as the positive electrode current collecting plate 24 but has a different band-shaped portion 34. The band-shaped portion 34 of the negative electrode current-collecting plate 25 in FIG. 3B is shorter than the band-shaped portion 32 of the positive electrode current-collecting plate 24, without any portion corresponding to the insulating portion 32A. The band-shaped portion 34 has a round protrusions (projections) 37 as shown in FIGS. 3B, 15B, and 15D that can be used to weld the band-shaped portion 35 to the exterior can 11. The flat fan-shaped portion 33 and the rectangular band-shaped portion 34 can be connected to define two corners 48. As shown in FIGS. 3B, 15B, and 15D, each of the two corners 48 can be curved. The fan-shaped portion 33 includes a curved portion and two straight-line portions. As shown in FIGS. 3B, 15B, and 15D, the lines 49 of the two straight-line portions can be co-linear or substantially co-linear within manufacturing and/or measurement tolerances. During resistance welding, current is concentrated on the protrusion, and the protrusion is melted to weld the band-shaped portion 34 to the bottom of the exterior can 11. Similarly to the positive electrode current-collecting plate 24, the negative electrode current-collecting plate 25 includes a hole 36 near the center of a fan-shaped portion 33, and the hole 36 is located at a position corresponding to the through hole 26 so that the hole 36 is aligned with the through hole 26. The fan-shaped portion 31 of the positive electrode current-collecting plate 24 and the fan-shaped portion 33 of the negative electrode current-collecting plate 25 can have a fan shape and thus cover a portion of the ends 41 and 42. The reason that the hole 36 is not covered is to allow an electrolytic solution to smoothly permeate the electrode wound body 20 in the assembly of the battery 1, or to make it easier for the gas generated when the battery reaches an abnormally high-temperature state or overcharge state to be released to the outside of the battery 1.

The positive electrode active material layer 21B includes, as a positive electrode active material, any one of or two or more of positive electrode materials capable of occluding and releasing lithium. However, the positive electrode active material layer 21B can further include any one of or two or more of other materials such as a positive electrode binder and a positive electrode conductive agent. The positive electrode material can be a lithium-containing compound, and more specifically, can be a lithium-containing composite oxide, a lithium-containing phosphate compound, or the like.

The lithium-containing composite oxide is an oxide containing lithium and one, or two or more other elements (elements other than lithium) as constituent elements, and the oxide can include, for example, any of a layered rock salt-type crystal structure, a spinel-type crystal structure, and the like. The lithium-containing phosphate compound is a phosphate compound containing lithium and one of or two or more of other elements as constituent elements, and the compound can include an olivine-type crystal structure or the like.

The positive electrode binder includes any one of or two or more of synthetic rubbers and polymer compounds, for example. The synthetic rubbers can be, for example, styrene-butadiene rubbers, fluorine rubbers, ethylene propylene diene, and the like. Examples of the polymer compounds can include a polyvinylidene fluoride and a polyimide. The positive electrode conductive agent can include, for example, any one of or two or more of carbon materials and the like, for example. The carbon materials can be, for example, graphite, carbon black, acetylene black, Ketjen black, and the like. The positive electrode conductive agent can be, however, a metal material, a conductive polymer, or the like as long as the agent is a conductive material.

The surface of the negative electrode foil 22A can be roughened. This is because the adhesion of the negative electrode active material layer 22B to the negative electrode foil 22A is improved due to a so-called anchor effect. In this case, the surface of the negative electrode foil 22A has only to be roughened at least in a region opposed to the negative electrode active material layer 22B. The roughening method is, for example, a method such as forming fine particles through the use of electrolytic treatment. The electrolytic treatment provides the surface of the negative electrode foil 22A with irregularities, because fine particles are formed on the surface of the negative electrode foil 22A with an electrolytic method in an electrolytic cell. Copper foil prepared by an electrolytic method is generally referred to as electrolytic copper foil.

The negative electrode active material layer 22B can include, as a negative electrode active material, any one of or two or more of negative electrode materials capable of occluding and releasing lithium. The negative electrode active material layer 22B can, however, further include any one of or two or more of other materials such as a negative binder and a negative electrode conductive agent.

The negative electrode material can be, for example, a carbon material. This is because a high energy density can be stably achieved due to the very small change in crystal structure at the time of occlusion and release of lithium. In addition, this is because the carbon materials also function as negative electrode conductive agents, thus improving the conductivity of the negative electrode active material layer 22B.

The carbon materials can be, for example, graphitizable carbon, non-graphitizable carbon, and graphite. However, the interplanar spacing of the (002) plane in the non-graphitizable carbon can be approximately 0.37 nm or more within manufacturing and/or measurement tolerances, and the interplanar spacing of the (002) plane in the graphite can be approximately 0.34 nm or less within manufacturing and/or measurement tolerances. More specifically, the carbon materials can be, for example, pyrolytic carbons, coke, glassy carbon fibers, fired products of organic polymer compounds, activated carbon, carbon blacks, and the like. Examples of the coke include pitch coke, needle coke, and petroleum coke. The fired products of organic polymer compounds are obtained by firing (carbonizing) polymer compounds such as a phenol resin and a furan resin at appropriate temperatures. Besides, the carbon materials can be low-crystallinity carbon subjected to a heat treatment at a temperature of about 1000° C. or lower or can be amorphous carbon. The shapes of the carbon materials can be any of fibrous, spherical, granular, or scaly.

In the battery 1, when the open-circuit voltage (that is, the battery voltage) in a fully charged case is about 4.25 V or higher, the release amount of lithium per unit mass is increased also with the use of the same positive electrode active material as compared with a case where the open-circuit voltage in the fully charged case is about 4.20 V, and the amount of the positive electrode active material and the amount of the negative electrode active material are thus adjusted accordingly. Thus, a high energy density can be achieved.

The separator 23 is interposed between the positive electrode 21 and the negative electrode 22 to allow passage of lithium ions while preventing a short circuit due to the current caused by the contact between the positive electrode 21 and the negative electrode 22. The separator 23 is any one of or two or more of porous membranes such as synthetic resins and ceramics, for example, and can be a laminated film of two or more porous membranes. The synthetic resins can be, for example, polytetrafluoroethylene, polypropylene, polyethylene, and the like.

In particular, the separator 23 can include, for example, the above-mentioned porous film (substrate layer), and a polymer compound layer provided on one or both sides of the substrate layer. This is because the adhesion of the separator 23 to each of the positive electrode 21 and the negative electrode 22 is improved, thus keeping the electrode wound body 20 from warping. Thus, the inhibited decomposition reaction of the electrolytic solution, and also, the suppressed leakage of the electrolytic solution with which the substrate layer impregnated, make the resistance less likely to increase also with repeated charging/discharging, and keep the secondary battery from swelling.

The polymer compound layer contains, for example, a polymer compound such as a polyvinylidene fluoride. This is because the polymer compound is excellent in physical strength and electrochemically stable. The polymer compound can be, however, a compound other than a polyvinylidene fluoride. In the case of forming the polymer compound layer, for example, a solution in which a polymer compound is dissolved in an organic solvent or the like is applied to the substrate layer, and then the substrate layer is dried. After immersing the substrate layer in the solution, the base material layer can be dried. This polymer compound layer can include any one of or two or more of insulating particles such as inorganic particles, for example. The type of the inorganic particles is, for example, an aluminum oxide, an aluminum nitride, or the like.

The electrolytic solution includes a solvent and an electrolyte salt. The electrolytic solution can further include, however, any one of or two or more of other materials such as additives.

The solvent includes any one of or two or more of nonaqueous solvents such as organic solvents. The electrolytic solution including a nonaqueous solvent is a so-called nonaqueous electrolytic solution.

The nonaqueous solvent is, for example, a cyclic carbonate, a chain carbonate, a lactone, a chain carboxylate, a nitrile (mononitrile), or the like. The electrolyte salt includes any one of or two or more of salts such as lithium salts, for example. However, the electrolyte salt can contain a salt other than lithium salts, for example. The salt other than lithium can be, for example, salts of light metals other than lithium.

The lithium salt can be, for example, lithium hexafluorophosphate (LiPF₆), lithium tetrafluoroborate (LiBF₄), lithium perchlorate (LiClO₄), lithium hexafluoroarsenate (LiAsF₆), lithium tetraphenylborate (LiB(C₆H₅)₄), lithium methanesulfonate (LiCH₃SO₃), lithium trifluoromethanesulfonate (LiCF₃SO₃), lithium tetrachloroaluminate (LiAlCl₄), dilithium hexafluorosilicate (Li₂SF₆), lithium chloride (LiCl), and lithium bromide (LiBr), and the like.

Any one of or two or more of lithium hexafluorophosphate, lithium tetrafluoroborate, lithium perchlorate, and lithium hexafluoroarsenate can be used.

The content of the electrolyte salt is not particularly limited but can be approximately 0.3 mol/kg to approximately 3 mol/kg within manufacturing and/or measurement tolerances with respect to the solvent.

A method for manufacturing the battery 1 is described with reference to FIGS. 4A-4F. First, a positive electrode active material 21B can be applied to the surface of the band-shaped positive electrode foil 21A to form a covered portion of the positive electrode 21 and an uncovered portion of the positive electrode 21 (e.g., the positive foil extension 21C), and a negative electrode active material 22B can be applied to the surface of the band-shaped negative electrode foil 22A to form a covered portion for the negative electrode 22 and a non-covered portion of the negative electrode 22 (e.g., the negative foil extension 22C). The positive and negative foil extensions 21C and 22C without the positive electrode active material 21B or negative electrode active material 21B applied can be prepared at one end of the positive electrode 21 in the widthwise direction and one end of the negative electrode 22 in the widthwise direction. Notches can be formed in portions of the positive and negative foil extensions 21C and 22C, corresponding to the winding starts at the time of winding. The positive electrode 21 and the negative electrode 22 can be subjected to steps such as drying. Then, the positive and negative electrodes 21, 22 can be stacked with the separator 23 interposed therebetween such that the positive foil extension 21C of the positive electrode 21 and the negative foil extension 22C of the negative electrode 22 can be oriented in opposite directions, and spirally wound so as to form the through hole 26 with the central axis extending through the through 26 and dispose the notches near the central axis, thereby preparing the electrode wound body 20 as shown in FIG. 4A.

Next, as shown in FIG. 4B, an end of a thin flat plate (for example, 0.5 mm in thickness) or the like can be pressed perpendicularly or substantially perpendicularly within manufacturing and/or measurement tolerances to the ends 41 and 42 to locally bend the ends 41 and 42 and then prepare the grooves 43. The grooves 43 can be formed using a grooving tool that is not pointed so that the positive and negative electrode foils 21A, 22A are not damaged. The grooves 43 extending toward the central axis can be prepared in a radial direction with the through hole 26 in the center. The number of the grooves 43 and the arrangement, shown in FIG. 4B, is considered by way of example only, and any number and arrangement of grooves 43 can be used. Then, as shown in FIG. 4C, the same pressure can be applied simultaneously from both sides in a direction perpendicular or substantially perpendicular to the ends 41 and 42 to bend the positive foil extension 21C of the positive electrode 21 and the negative foil extension 22C of the negative electrode 22, and then can form the ends 41 and 42 to define flat surfaces. The load can be applied with the plate surface of the flat plate or the like such that bends in the portions of the positive foil extension 21C at the end 41 overlap and bend toward the through hole 26 and such that bends in portions of the negative foil extensions 22C at the end 42 overlap and bend toward the through hole 26. Thereafter, the fan-shaped portion 31 of positive electrode current-collecting plate 24 was joined (e.g., by laser welding) to the end 41, and the fan-shaped portion 33 of the negative electrode current-collecting plate 25 was joined (e.g., by laser welding) to the end 42.

Thereafter, as shown in FIG. 4D, the band-shaped portions 32 and 34 of the current collecting plates 24, 25 can be bent, and the insulating plates 12 and 13 (or insulating tapes) can be attached to the positive electrode current collecting plate 24 and the negative electrode current collecting plate 25. As shown in FIGS. 13A, 13B, 13C, 13F, and 13G, insulator 53 can be applied to the positive end of the electrode wound body 20, and as shown in FIGS. 13A, 13D, 13E, 13H, and 13I, insulator 54 can be applied to the negative end of the electrode wound body 20. The insulator 53 can cover a portion of the sides of the electrode wound body 20 and a portion of the end 41 such that the rectangular band-shaped portion 32 of the positive electrode current-collection plate 24 extends away from the end 41, and the insulator 54 can cover a portion of the sides of the electrode wound body 20 and a portion of the end 42 such that the band-shaped portion 34 of the negative electrode current-collection plate 25 extends away from the end 42. As shown in FIGS. 14A, 14B, 14C, 14F, and 14G, the insulating plate 12 can include an extraction port through which the rectangular band-shaped portion 32 of the positive electrode current-collection plate 24 can extend, a larger hole 45 that corresponds to the through hole 26 in the electrode wound body 20 so that the larger hole 45 is aligned with the through hole 26, and smaller holes 46 arranged around the larger hole 45 that can be used to penetrate the electrolyte. As shown in FIGS. 14A, 14D, 14E, 14H, and 14I, the insulating plate 13 can include an extraction port through which the band-shaped portion 34 of the negative electrode current-collection plate 25 can extend and a hole corresponding to the through hole 26 in the electrode wound body 20 so that the hole is aligned with the through hole 26.

After the insulating plates 12 and 13 are attached to the positive electrode current collecting plate 24 and the negative electrode current collecting plate 25, the electrode wound body 20 assembled as mentioned above can be inserted into the exterior can 11 as shown in FIG. 4E, and the bottom of the exterior can 11 can be welded. After injecting an electrolytic solution into the exterior can 11, sealing can be performed with the gasket 15 and the battery cover 14 as shown in FIG. 4F.

It should be understood that the foregoing description is only illustrative of the present invention. Various alternatives and modifications can be devised by those skilled in the art without departing from the present invention. Accordingly, the present invention is intended to embrace all such alternatives, modifications, and variances that fall within the scope of the appended claims.

What is claimed is:

1. An electrode wound body comprising:
a positive electrode including:
a positive electrode foil;
a positive electrode active material on a portion of the positive electrode foil; and
a positive foil extension extending from the positive electrode foil, wherein the positive electrode active material is not on the positive foil extension;
a negative electrode including:
a negative electrode foil;
a negative electrode active material on a portion of the negative electrode foil; and
a negative foil extension extending from the negative electrode foil, wherein the negative electrode active material is not on the negative foil extension; and
a separator between the positive electrode and the negative electrode; wherein
the positive electrode, the negative electrode, and the separator are wound to define a spiral including a through hole with a central axis extending through the through hole;
the positive foil extension extends from a first end of the electrode wound body;
the negative foil extension extends from a second end of the electrode wound body opposite to the first end;
portions of the positive foil extension include first bends that bend towards the central axis so that the portions of the positive foil extension overlap to define a first surface;
the positive foil extension includes a first groove in the first surface;
portions of the negative foil extension include second bends that bend towards the central axis so that the portions of the negative foil extension overlap to define a second surface; and
the negative foil extension includes a second groove in the second surface.

2. The electrode wound body of claim 1, wherein
a bottom surface of the first groove is curved; and
a bottom surface of the second groove is curved.

3. The electrode wound body of claim 2, wherein a first curvature of the first groove is less than a second curvature of the second groove.

4. The electrode wound body of claim 1, wherein the second groove is deeper than the first groove.

5. The electrode wound body of claim 1, wherein each of the first and the second grooves has a rectangular cross section.

6. The electrode wound body of claim 1, wherein portions of the separator include third bends.

7. The electrode wound body of claim 1, wherein
portions of the positive electrode active material include fourth bends; and
portions of the negative electrode active material include fifth bends.

8. The electrode wound body of claim 1, wherein a portion of the positive electrode foil and/or a portion of the negative electrode foil is folded over an innermost portion of the separator closest to the through hole.

9. The electrode wound body of claim 1, wherein
some portions of the positive foil extension include multiple first bends;
some portions of the negative foil extension include multiple second bends; and
a number of the multiple first bends of the positive foil extension is greater than a number of the multiple second bends of the negative foil extension.

10. The electrode wound body of claim 1, wherein
first bending shapes of the first bends of the positive foil extension are asymmetric with respect to the central axis; and
second bending shapes of the second bends of the negative foil extension are asymmetric with respect to the central axis.

11. The electrode wound body of claim 1, further comprising a cavity between radially adjacent first bends of the positive foil extension or between radially adjacent second bends of the negative foil extension.

12. The electrode wound body of claim 1, wherein
the first surface is substantially smooth with a glossy appearance; and
the second surface is substantially smooth with a glossy appearance.

13. The electrode wound body of claim 1, wherein
a first distance between radially adjacent portions of the positive foil extension decreases as a second distance to the negative electrode active material increases; and
a third distance between radially adjacent portions of the negative foil extension decreases as a fourth distance from the positive electrode active material increases.

14. The electrode wound body of claim 1, wherein
a first distance between radially adjacent portions of the positive foil extension decreases as a second distance to the through hole decreases; and
a third distance between radially adjacent portions of the negative foil extension decreases as a fourth distance to the through hole decreases.

15. The electrode wound body of claim 1, wherein
a fitting degree of radially adjacent portions of the positive foil extension increases as a first distance to the through hole decreases; and
a fitting degree of radially adjacent portions of the negative foil extension increases as a second distance to the through hole decreases.

16. A battery comprising:
an exterior can; and
the electrode wound body of claim 1 in the exterior can.

17. The battery of claim 16, further comprising:
a positive electrode current-collecting plate joined to the first surface and including a first flat fan-shaped portion and a first rectangular band-shaped portion; and
a negative electrode current-collecting plate joined to the second surface and including a second flat fan-shaped portion and a second rectangular band-shaped portion.

18. The battery of claim 17, wherein, after the positive electrode current-collecting plate and the negative electrode current-collecting plate are joined to the first and second surfaces, respectively, the first groove does not retain a cross-sectional shape, and the second groove retains a cross-sectional shape.

19. The battery of claim 17, wherein
the first fan-shaped portion of the positive electrode current-collecting plate includes a first curved portion and two first straight-line portions with two first lines of the two first straight-line portions being co-linear; and
the second fan-shaped portion of the negative electrode current-collecting plate includes a second curved portion and two second straight-line portions with two second lines of the two second straight-line portions being co-linear.

20. The battery of claim 17, wherein
the first flat fan-shaped portion and the first rectangular band-shaped portion of the positive electrode current-collecting plate are connected at two first curved corners; and
the second flat fan-shaped portion and the second rectangular band-shaped portion of the negative electrode current-collecting plate are connected at two second curved corners.

21. The battery of claim 17, further comprising:
a positive insulator that is joined to the positive electrode current-collecting plate and that includes a larger hole that is aligned with the through hole and that includes smaller holes arranged around the larger hole; and
a negative insulator that is joined to the negative electrode current-collecting plate and that includes a hole that is aligned with the through hole.

22. An electrode wound body comprising:
a positive electrode including:
a positive electrode foil;
a positive electrode active material on a portion of the positive electrode foil; and
a positive foil extension extending from the positive electrode foil, wherein the positive electrode active material is not on the positive foil extension;
a negative electrode including:
a negative electrode foil;
a negative electrode active material on a portion of the negative electrode foil; and
a negative foil extension extending from the negative electrode foil, wherein the negative electrode active material is not on the negative foil extension; and
a separator between the positive electrode and the negative electrode; wherein
the positive electrode, the negative electrode, and the separator are wound to define a spiral including a through hole with a central axis extending through the through hole;
the positive foil extension extends from a first end of the electrode wound body;
the negative foil extension extends from a second end of the electrode wound body opposite to the first end;
portions of the positive foil extension include first bends that bend towards the central axis so that the portions of the positive foil extension overlap to define a first surface;
first bending shapes of the first bends of the positive foil extension are asymmetric with respect to the central axis;
portions of the negative foil extension include second bends that bend towards the central axis so that the portions of the negative foil extension overlap to define a second surface; and
second bending shapes of the second bends of the negative foil extension are asymmetric with respect to the central axis.

23. The electrode wound body of claim 22, wherein
some portions of the positive foil extension include multiple first bends;
some portions of the negative foil extension include multiple second bends; and
a number of multiple first bends of the positive foil extension is greater than a number of multiple second bends of the negative foil extension.

24. The electrode wound body of claim 22, wherein portions of the separator include third bends.

25. The electrode wound body of claim 22, wherein
portions of the positive electrode active material include fourth bends; and
portions of the negative electrode active material include fifth bends.

26. The electrode wound body of claim 22, wherein a portion of the positive electrode foil and/or a portion of the negative electrode foil is folded over an innermost portion of the separator closest to the through hole.

27. The electrode wound body of claim 22, wherein
the positive foil extension includes a first groove in the first surface; and
the negative foil extension includes a second groove in the second surface.

28. The electrode wound body of claim 22, wherein
a bottom surface of the first groove is curved; and
a bottom surface of the second groove is curved.

29. The electrode wound body of claim 28, wherein a first curvature of the first groove is less than a second curvature of the second groove.

30. The electrode wound body of claim 27, wherein the second groove is deeper than the first groove.

31. The electrode wound body of claim 22, further comprising a cavity between radially adjacent first bends of the positive foil extension or between radially adjacent second bends of the negative foil extension.

32. The electrode wound body of claim 22, wherein
the first surface is substantially smooth with a glossy appearance; and
the second surface is substantially smooth with a glossy appearance.

33. The electrode wound body of claim 22, wherein
a first distance between radially adjacent portions of the positive foil extension decreases as a second distance to the negative electrode active material increases; and
a third distance between radially adjacent portions of the negative foil extension decreases as a fourth distance from the positive electrode active material increases.

34. The electrode wound body of claim 22, wherein
a first distance between radially adjacent portions of the positive foil extension decreases as a second distance to the through hole decreases; and
a third distance between radially adjacent portions of the negative foil extension decreases as a fourth distance to the through hole decreases.

35. The electrode wound body of claim 22, wherein
a fitting degree of radially adjacent portions of the positive foil extension increases as a first distance to the through hole decreases; and
a fitting degree of radially adjacent portions of the negative foil extension increases as a second distance to the through hole decreases.

36. A battery comprising:
an exterior can; and
the electrode wound body of claim 22 in the exterior can.

37. The battery of claim 36, further comprising:
a positive electrode current-collecting plate joined to the first surface and including a first flat fan-shaped portion and a first rectangular band-shaped portion; and
a negative electrode current-collecting plate joined to the second surface and including a second flat fan-shaped portion and a second rectangular band-shaped portion.

38. The battery of claim 37, wherein, after the positive electrode current-collecting plate and the negative electrode current-collecting plate are joined to the first and second surfaces, respectively, the first groove does not retain a cross-sectional shape, and the second groove retains a cross-sectional shape.

39. The battery of claim 37, wherein
the first fan-shaped portion of the positive electrode current-collecting plate includes a first curved portion and two first straight-line portions with two first lines of the two first straight-line portions being co-linear; and
the second fan-shaped portion of the negative electrode current-collecting plate includes a second curved portion and two second straight-line portions with two second lines of the two second straight-line portions being co-linear.

40. The battery of claim 36, wherein
the first flat fan-shaped portion and the first rectangular band-shaped portion of the positive electrode current-collecting plate are connected at two first curved corners; and
the second flat fan-shaped portion and the second rectangular band-shaped portion of the negative electrode current-collecting plate are connected at two second curved corners.

41. The battery of claim 36, further comprising:
a positive insulator that is joined to the positive electrode current-collecting plate and that includes a larger hole that is aligned with the through hole and that includes smaller holes arranged around the larger hole; and
a negative insulator that is joined to the negative electrode current-collecting plate and that includes a hole that is aligned with the through hole.
